(19) United States
(12) Patent Application Publication
(10) Pub. No.: US 2025/0322396 A1
(43) Pub. Date: Oct. 16, 2025

(54) ENCRYPTED SUBNETS AND SECURE CONTAINERS

(71) Applicant: Fr0ntierX Inc., Brooklyn, NY (US)

(72) Inventors: Vladimir Haltakov, Munich (DE); Jens Albers, Princeton, NJ (US); Jonathan Begg, New York, NY (US); Andrew Gilbert, Charlotte, NC (US)

(21) Appl. No.: 19/180,648

(22) Filed: Apr. 16, 2025

Related U.S. Application Data
(60) Provisional application No. 63/634,583, filed on Apr. 16, 2024.
(60) Provisional application No. 63/722,132, filed on Nov. 19, 2024.

(51) Int. Cl. G06Q 20/40; G06Q 20/36; G06Q 20/38

(52) U.S. Cl. CPC G06Q 20/401; G06Q 20/367; G06Q 20/389

(57) ABSTRACT

A method for verifying transactions in a subnet by a validator node of the subnet includes receiving, from a user of the subnet, an encrypted transaction, the transaction being encrypted by a public key associated with an auditor of the subnet. The method further includes providing a decryption request to a digital wallet, the request including encrypted data from the transaction. The method further includes receiving decrypted data from the digital wallet in response to the decryption request, and using the decrypted data, performing a verification operation on the transaction.

### CROSS-REFERENCE OF RELATED APPLICATION

This application claims the benefit of U.S. Provisional Application No. 63/634,583, filed on Apr. 16, 2024, and of U.S. Provisional Application No. 63/722,132, filed on Nov. 19, 2024, which are incorporated herein in their entirety.

### TECHNICAL FIELD

The present disclosure generally relates to blockchain technology, and more particularly to encrypting transactions in a blockchain using a cryptographic wallet.

### BACKGROUND

When using cloud computing platforms, there is a need to isolate sensitive data processing pipelines from cloud service providers and non-essential internal resources, ensuring the confidentiality and integrity of critical information. Organizations have a need to securely process data across multiple parties without exposing themselves to unauthorized access or compromised credentials.

Subnets in blockchains have many uses for processing secure transaction data. However, validator nodes require access to the unencrypted content of transactions, so they are able to validate each transaction and agree with the other nodes included in a block. However, an operator of a validator node may also be able to access the data within these transactions.

As such, there is a need for protecting data within transactions so that the validator nodes may access the data needed for consensus mechanisms, but without potentially revealing the data to the node operator.

As organizations transition from traditional on-premises data centers to cloud-based solutions, ensuring the security of the data becomes a priority. Common concerns include vulnerabilities related to infrastructure breaches by external hackers, internal threats from malicious insiders, and unauthorized data access by cloud provider administrators.

These security concerns primarily arise because conventional architectures mandate decrypting data during processing, despite encryption at rest and in transit. This requirement introduces vulnerabilities where sensitive data can potentially be exposed.

As such, there is a need for mitigating this risk by performing secure computation directly on encrypted data.

### SUMMARY

According to some embodiments, a method for verifying transactions in a subnet by a validator node of the subnet includes receiving, from a user of the subnet, a transaction encrypted by a public key associated with an auditor of the subnet. The method further includes providing a decryption request to a digital wallet, the request including encrypted data from the transaction. The method further includes receiving decrypted data from the digital wallet in response to the decryption request, and using the decrypted data, performing a verification operation on the transaction.

According to some embodiments, a non-transitory computer-readable medium stores a program for verifying transactions in a subnet by a validator node of the subnet, which when executed by a computer, configures the computer to receive, from a user of the subnet, a transaction encrypted by a public key associated with an auditor of the subnet. The executed program further configures the computer to provide a decryption request to a digital wallet, the request including encrypted data from the transaction. The executed program further configures the computer to receive decrypted data from the digital wallet in response to the decryption request, and using the decrypted data, perform a verification operation on the transaction. Furthermore, the validator node uses an application programming interface of the digital wallet to provide the decryption request to the digital wallet.

According to some embodiments, a system for verifying transactions in a subnet by a validator node of the subnet includes a processor and a non-transitory computer readable medium storing a set of instructions, which when executed by the processor, configure the processor to receive, from a user of the subnet, a transaction encrypted by a public key associated with an auditor of the subnet. The executed instructions further configure the processor to provide a decryption request to a digital wallet, the request including encrypted data from the transaction. The executed instructions further configure the processor to receive decrypted data from the digital wallet in response to the decryption request, and using the decrypted data, perform a verification operation on the transaction. Furthermore, the validator node uses an application programming interface of the digital wallet to provide the decryption request to the digital wallet.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to implement encrypted subnets and secure containers, according to some embodiments.

FIG. 2 is a block diagram illustrating details of a system for implementing encrypted subnets and secure containers, according to some embodiments.

FIG. 3 is a block diagram illustrating details of a system for implementing encrypted subnets, according to some embodiments.

FIG. 4 is a block diagram illustrating details of a system for implementing a digital wallet, according to some embodiments.

FIG. 5 is a block diagram illustrating details of a system for implementing a digital wallet, according to some embodiments.

FIG. 6 is a block diagram illustrating details of a system for implementing a digital wallet, according to some embodiments.

FIG. 7 is a block diagram illustrating details of a system for implementing a digital wallet, according to some embodiments.

FIG. 8A shows an example of a digital wallet responding to a wallet creation request.

FIG. 8B shows an example of a digital wallet responding to a signature request.

FIG. 8C shows an example of a digital wallet responding to a decryption request.

FIGS. 9A and 9B show a block diagram illustrating details of a digital wallet API for encrypted transactions, according to some embodiments.

FIG. 10 is a flowchart illustrating a process for verifying transactions in a subnet performed by a validator node of the subnet, according to some embodiments.

FIG. 11 shows an example of a DID token, according to some embodiments.

FIG. 12 shows an example of a signature using individual private keys, according to some embodiments.

FIGS. 13A and 13B show an example of a signature using multiple master keys, according to some embodiments.

FIGS. 14A-14D are a block diagram illustrating a system for implementing secure containers, according to some embodiments.

FIG. 15 is a flowchart illustrating a process for providing secure containers, according to some embodiments.

FIG. 16 illustrates an example of a secure container, according to some embodiments.

FIGS. 17A-17F illustrate another example of a secure container, according to some embodiments.

FIG. 18 illustrates a base client setup, according to some embodiments.

FIG. 19 illustrates an example of protecting a workload using a secure container, according to some embodiments.

FIGS. 20A and 20B illustrate an example of protecting a storage using a secure container, according to some embodiments.

FIG. 21 illustrates an example of protecting input using a secure container, according to some embodiments.

FIG. 22 illustrates an example of protecting output using a secure container, according to some embodiments.

FIGS. 23A-23C illustrate an example of communication between secure containers, according to some embodiments.

FIG. 24 is a block diagram illustrating an exemplary computer system with which aspects of the subject technology can be implemented, according to some embodiments.

FIG. 25 is a block diagram illustrating a use case of a secure container for an anonymization service, according to some embodiments.

FIG. 26 is a block diagram illustrating a use case of a secure container for a data processing pipeline, according to some embodiments.

FIG. 27 is a block diagram illustrating a use case of a secure container for a web application backend, according to some embodiments.

FIG. 28 is a block diagram illustrating a use case of a secure container for database servers, according to some embodiments.

FIG. 29 is a block diagram illustrating a use case of a secure container for an end to end encrypted chatbot, according to some embodiments.

FIG. 30 is a block diagram illustrating a use case of a secure container for a Kubernetes cluster, according to some embodiments.

FIG. 31 is a block diagram illustrating a system with different types of keys used with a secure container, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

The term “blockchain” as used herein refers, according to some embodiments, to a decentralized, distributed ledger technology that securely records transactions across a network of computers. Each block in the chain contains a cryptographic hash of the previous block, creating a tamper-resistant system where data is stored in a chronological and immutable manner. This technology enables transparent and verifiable transactions without the need for intermediaries, ensuring trust and security in various applications such as financial transactions, supply chain management, and smart contracts.

Private blockchains are blockchain networks controlled by a single entity or organization that restricts access to verified participants. Unlike public blockchains that are open to anyone, private blockchains have centralized governance, allowing the designated authority to manage permissions, monitor activities, and regulate access to the network.

A permissioned blockchain is a type of private blockchain, or alternatively may be considered a hybrid of a public and a private blockchain, where multiple users are given permissions to access and perform specific activities on the network. Unlike public blockchains, which are open to anyone, permissioned blockchains have an access control layer that allows only verified participants to join the network. This layer of security ensures that only authorized users can perform certain actions within the network's defined roles and permissions.

Nodes in blockchain technology pay various roles in maintaining the integrity, security, and functionality of a blockchain network. There are different types of nodes, including full nodes, light nodes, and validator nodes (herein equivalently referred to as validators). Validator nodes are responsible for verifying transactions and adding them to the distributed ledger. Validators usually require access to the content of transactions, so they are able to validate each transaction and agree with other nodes included in a block. Nodes communicate with each other through a peer-to-peer network, ensuring consensus on the state of the blockchain and validating transactions to prevent malicious activities like double-spending. Accordingly, validator nodes uphold the security and stability of blockchain networks by executing consensus mechanisms and maintaining the decentralized nature of the system.

The term “subnets” as used herein refers, in some embodiments, to dynamic sets of validator nodes that work together to achieve consensus on the state of a set of blockchains. Each blockchain is validated by exactly one subnet, and a subnet can validate many blockchains. A node may be a member of many subnets. Subnets enable interoperability and flexibility by allowing different sub-networks to communicate with each other and share data. They can be used to create customizable blockchain solutions that meet specific needs of different applications, such as private blockchains for financial services or specialized nodes for validating transactions or executing smart contracts.

The term “cryptocurrency” as used herein refers, according to some embodiments, to digital or virtual forms of currency that utilize cryptographic technology to secure transactions, control the creation of new units, and verify the transfer of assets. These digital currencies operate independently of central banks and governments, relying on decentralized networks like blockchain technology to record transactions securely. Each cryptocurrency unit ownership is stored in a digital ledger, ensuring transparency and immutability.

The term “digital wallet” as used herein refers, according to some embodiments, to a digital tool that allows users to securely store, manage, and interact with cryptocurrencies in a blockchain. Such digital wallets store private keys that enable users to access their data on the blockchain. These digital wallets provide a secure way to send, receive, and monitor transactions.

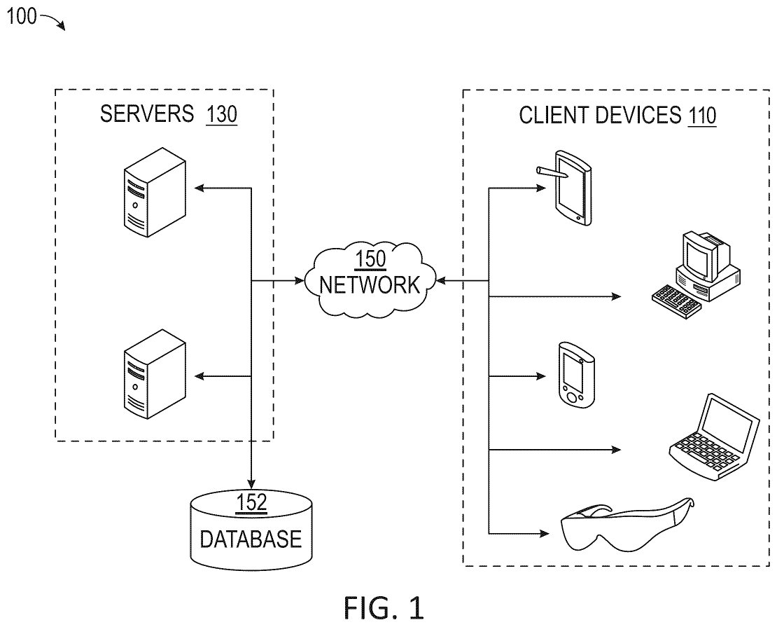

FIG. 1 illustrates a network architecture 100 used to implement encrypted subnets and secure containers, according to some embodiments. The network architecture 100 may include one or more client devices 110 and servers 130, communicatively coupled via a network 150 with each other and to at least one database, e.g., database 152. Database 152 may store data and files associated with the servers 130 and/or the client devices 110. In some embodiments, client devices 110 collect data, video, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, laptop computers, desktop computers, and mobile devices such as smart phones, tablets, televisions, wearable devices, head-mounted devices, display devices, and the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some embodiments, the servers 130 may include the client devices 110 as well, such that they are peers.

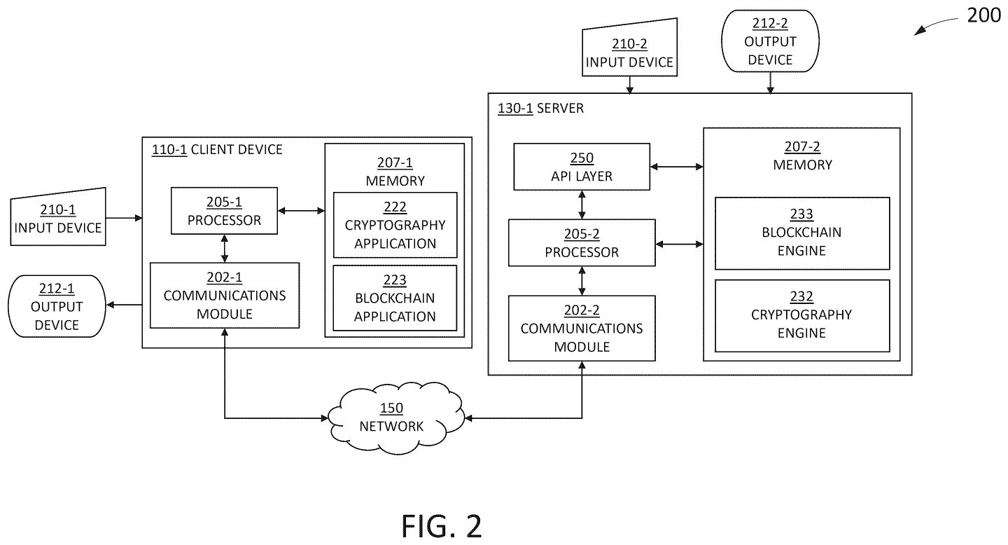

FIG. 2 is a block diagram illustrating details of a system 200 for implementing encrypted subnets and secure containers, according to some embodiments. Specifically, the example of FIG. 2 illustrates an exemplary client device 110-1 (of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150. Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include processors 205-1 and 205-2 and memories 207-1 and 207-2, respectively. Processors 205-1 and 205-2 and memories 207-1 and 207-2 will be collectively referred to, hereinafter, as “processors 205,” and “memories 207.” Processors 205 may be configured to execute instructions stored in memories 207, to cause client device 110-1 and/or server 130-1 to perform methods and operations consistent with embodiments of the present disclosure.

The client device 110-1 and the server 130-1 are each coupled to at least one input device 210-1 and input device 210-2, respectively (hereinafter, collectively referred to as “input devices 210”). The input devices 210 can include a mouse, a controller, a keyboard, a pointer, a stylus, a touchscreen, a microphone, voice recognition software, a joystick, a virtual joystick, a touch-screen display, and the like. In some embodiments, the input devices 210 may include cameras, microphones, sensors, and the like. In some embodiments, the sensors may include touch sensors, acoustic sensors, inertial motion units and the like.

The client device 110-1 and the server 130-1 are also coupled to at least one output device 212-1 and output device 212-2, respectively (hereinafter, collectively referred to as “output devices 212”). The output devices 212 may include a screen, a display (e.g., a same touchscreen display used as an input device), a speaker, an alarm, and the like. A user may interact with client device 110-1 and/or server 130-1 via the input devices 210 and the output devices 212. In some embodiments, the processor 205-1 is configured to control a graphical user interface (GUI) (e.g., spanning at least a portion of input devices 210 and output devices 212) for the user of client device 110-1 to access the server 130-1.

Memory 207-1 may further include a cryptography application 222, configured to execute on client device 110-1 and couple with input device 210-1 and output device 212-1. The cryptography application 222 may be downloaded by the user from server 130-1, and/or may be hosted by server 130-1. The cryptography application 222 may include specific instructions which, when executed by processor 205-1, cause operations to be performed consistent with embodiments of the present disclosure. In some embodiments, the cryptography application 222 runs on an operating system (OS) installed in client device 110-1. In some embodiments, cryptography application 222 may run within a web browser.

Memory 207-1 may further include a blockchain application 223, configured to execute on client device 110-1 and couple with input device 210-1 and output device 212-1. The blockchain application 223 may be downloaded by the user from server 130-1, and/or may be hosted by server 130-1. The blockchain application 223 may include specific instructions which, when executed by processor 205-1, cause operations to be performed consistent with embodiments of the present disclosure. In some embodiments, the blockchain application 223 runs on an operating system (OS) installed in client device 110-1. In some embodiments, blockchain application 223 may run within a web browser. In some embodiments, cryptography application 222 and blockchain application 223 may communicate with each other within memory 207-1.

In some embodiments, memory 207-2 includes a cryptography engine 232. The cryptography engine 232 may be configured to perform methods and operations consistent with embodiments of the present disclosure. The cryptography engine 232 may share or provide features and resources with the client device 110-1, including data, libraries, and/or applications retrieved with cryptography engine 232 (e.g., cryptography application 222, blockchain application 223, etc.). The user may access the cryptography engine 232 through the cryptography application 222 and/or the blockchain application 223. The cryptography application 222 and/or the blockchain application 223 may be installed in client device 110-1 by the cryptography engine 232 and/or may execute scripts, routines, programs, applications, and the like provided by the cryptography engine 232.

In some embodiments, memory 207-2 includes a blockchain engine 233. The blockchain engine 233 may be configured to perform methods and operations consistent with embodiments of the present disclosure. The blockchain engine 233 may share or provide features and resources with the client device 110-1, including data, libraries, and/or applications retrieved with blockchain engine 233 (e.g., cryptography application 222, blockchain application 223, etc.). The user may access the blockchain engine 233 through the cryptography application 222 and/or the blockchain application 223. The cryptography application 222 and/or the blockchain application 223 may be installed in client device 110-1 by the blockchain engine 233 and/or may execute scripts, routines, programs, applications, and the like provided by the blockchain engine 233. In some embodiments, cryptography engine 232 and blockchain engine 233 may communicate with each other within memory 207-2.

In some embodiments, one or more of cryptography application 222 and/or blockchain application 223 may communicate with either cryptography engine 232, blockchain engine 233, or both, through an API layer 250.

### Encrypted Subnets

Embodiments of the present disclosure address the above identified problems using an encrypted, auditable, and permissioned subnet using a digital wallet.

Some embodiments allow different users to interact with smart contracts without revealing the data of the transaction(s) to others, including the validators, since they will be run by some of the participants within the subnet. A set of admin users would still have the ability to view all transactions unencrypted for auditability purposes.

Some embodiments are characterized by at least the following features: 1. The encrypted subnet is permissioned. 2. All transactions are stored encrypted at all times, both at rest and in transit. 3. For auditability purposes, a set of auditor users are able to decrypt transaction content. 4. Subnet nodes are able to validate blocks without modification to the Avalanche consensus mechanism. 5. Node operators cannot view unencrypted transactions.

In some embodiments, data fields of each transaction are encrypted while other fields are not encrypted.

In some embodiments, the events emitted from smart contracts are encrypted.

In some embodiments, transactions are encrypted on the user's device before they are submitted to the blockchain.

In some embodiments, transactions are stored in a protected memory area, referred to as a “mempool,” in encrypted form.

In some embodiments, transactions are stored on-chain in encrypted form.

In some embodiments, the subnet nodes have the ability to decrypt transactions.

In some embodiments, the node operator does not have the ability to view unencrypted transactions.

In some embodiments, a limited set of auditor users have the ability to decrypt all transactions.

In some embodiments, a limited set of admin users have the ability to add and remove auditors.

Some embodiments provide a technical solution based on a modified permissioned blockchain having validators deployed in a Trusted Execution Environment (TEE). Additionally, some embodiments provide encrypting or decrypting transaction data using a digital wallet, and more specifically in some examples, using an Application Programming Interface (API) to a digital wallet.

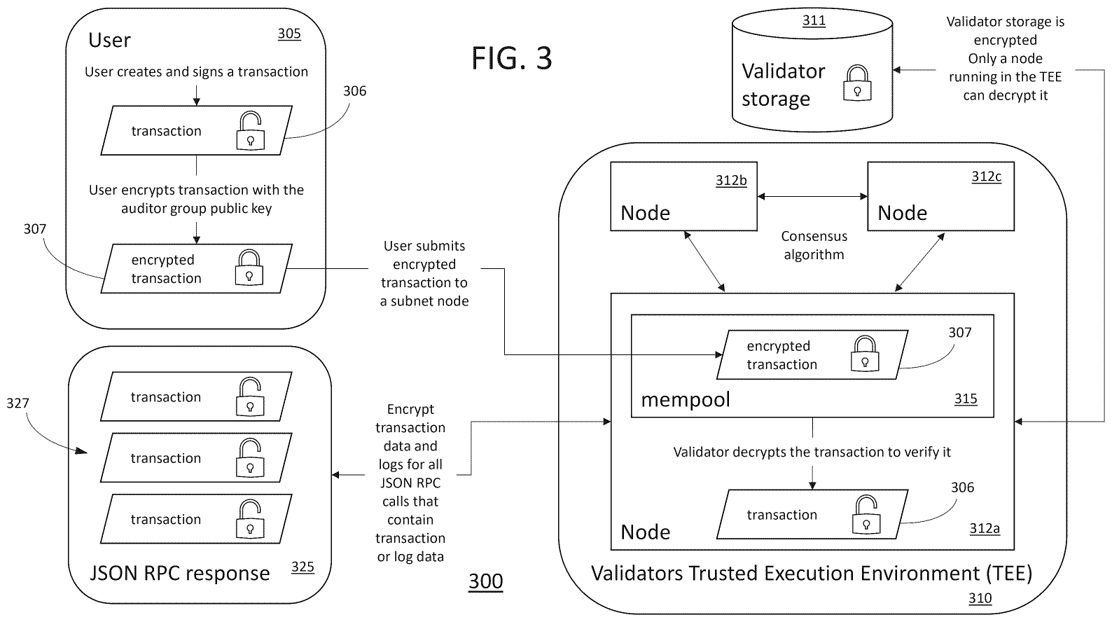

FIG. 3 is a block diagram illustrating details of a system 300 for implementing an encrypted subnet, according to some embodiments. In this example, a user 305 creates and signs a transaction 306 (e.g., on the user's device, such as client device 110-1), and then encrypts the data fields of the transaction before submitting the encrypted transaction 307 to a validator node of a subnet.

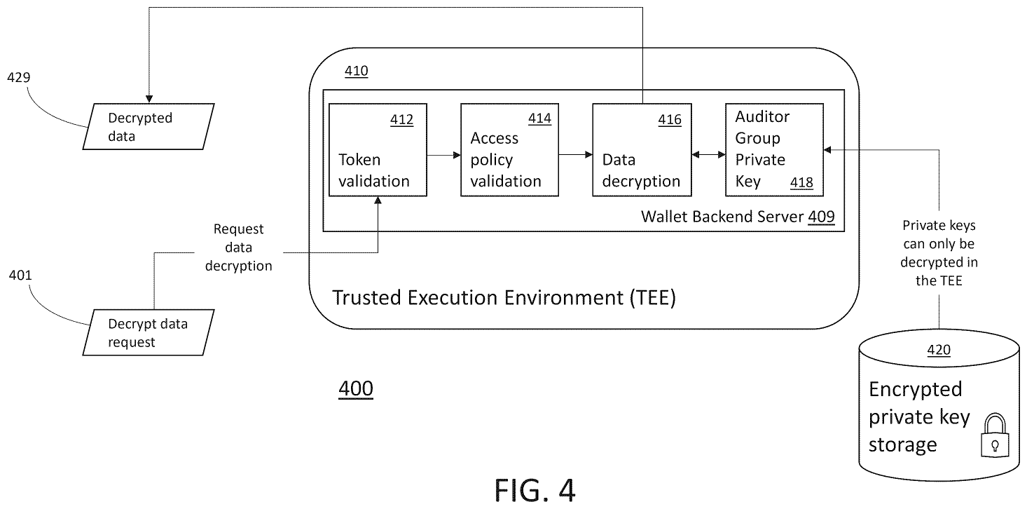

In some embodiments, the encryption may be performed using an Elliptic Curve Integrated Encryption Scheme (ECIES), in which the data field is encrypted with an auditor wallet's predefined public key. This means that only users with access to the corresponding private key will be able to decrypt the data. The access management for this private key may be performed in a non-custodial manner, an embodiment of which is described further below with respect to FIG. 4. Performing ECIES encryption requires no private key and can be done without any API calls.

In this example, the node operators in this subnet are not able to see the content of any transactions since the validator nodes are running in a trusted execution environment (TEE 310), and use an encrypted validator storage 311, such that only nodes running within the TEE 310 may access and decrypt data from the validator storage 311. Running validator nodes (e.g., validator node 312a, validator node 312b, and validator node 312c) in the TEE 310 means that the operator is not able to access (e.g., via Secure Shell SSH, or other protocols) the virtual machine executing the nodes or inspect the encrypted memory. Hereinafter, validator nodes 312a, 312b, 312c will be collectively referred to as “validator nodes 312.” Some embodiments utilize only pre-approved virtual machine or container images, to ensure that the node operator is not including modified code that allows for data to be exported.

In order to prevent a node operator from inspecting the data, the validator nodes 312 are required to use encrypted storage (e.g., validator storage 311). In some embodiments, a key stored in a Hardware Security Module (HSM) is configured so that only a virtual machine running in the TEE 310 is able to decrypt the data. Additionally, all HSM activity may be logged in the cloud, along with the ability to probe that the key has not been configured for other parties.

In this example, the encrypted transaction 307 is submitted to validator node 312a. Each of the validator nodes 312 has a memory pool (equivalently referred to as a “mempool”), which is where pending transactions are stored before they are validated. Accordingly, the encrypted transaction 307 is stored in the mempool 315 of validator node 312a.

The validator node 312a decrypts the encrypted transaction 307, resulting in the unencrypted transaction 306. Since the validator nodes 312 do not have access to the decryption private key, in some embodiments, they use a digital wallet API to decrypt the data. Embodiments of a digital wallet API are described in further detail below.

In some embodiments, the code for the validator nodes 312 is modified for all JSON RPC calls that return either data or transaction logs (e.g., as a JSON RPC response 325) containing smart contract events (e.g., transactions 327). Examples of such RPC calls include, but are not limited to, eth_getTransactionByHash, eth_getBlockByHash, and eth_getLogs. Before returning the transaction information, the data in the transactions 327 may be encrypted again using the public key from the auditor's group, i.e., the same mechanism used when submitting an initial transaction. This ensures that only the auditors are able to view any transaction content.

Some embodiments define a set of auditors who are the only limited set of users able to view all transactions unencrypted, and therefore, need to be able to use the private key that corresponds to the public one used to encrypt the data. However, sharing the private key with users is a major security issue as it may be unsafe to distribute a private key to more than one user, and there is no mechanism for revocation of access.

Accordingly, in some embodiments, a digital wallet is used to manage the auditor group's private key in a non-custodial manner, by implementing an access policy that determines which users are able to gain access to the key. In some embodiments, the digital wallet is accessed using an Application Programming Interface (API).

In some cases, the transaction 306 may not require encryption if the user 305 can directly communicate with one of the subnet nodes that are running in the TEE. However, even in such cases, it may still be advisable to encrypt all transactions because the transactions may at some point pass through an application backend.

FIG. 4 is a block diagram illustrating details of a system 400 for implementing a digital wallet, according to some embodiments. The system 400 is similar to the embodiment of the system 300 discussed above with respect to FIG. 3, or other system embodiments discussed below. A detailed description of some components of the system 400 will be omitted, and the following discussion focuses on the differences between these embodiments. Any of the various features discussed with any one of the embodiments discussed herein may also apply to and be used with any other embodiments.

In this example, the digital wallet is accessed via a digital wallet Application Programming Interface (API), and more specifically, a Hypertext Transfer Protocol (HTTP) API. In other embodiments, the wallet may be accessed using other protocols. In order for a user (e.g., a validator node, an auditor, etc.) to decrypt data, they submit a decryption request 401 using the digital wallet API (e.g., via an HTTP API call) and then authenticate the digital wallet API (e.g., using a JSON Web ID token according to the OpenID Connect standard) through a whitelisted identity provider (e.g., Google Identity) (not shown in FIG. 4). A digital wallet backend server 409 (e.g., server 130-1) executing in a TEE 410 validates the ID token, checks if the user belongs to a whitelist of users (e.g., auditors, validators, etc.), and decrypts the provided data. The decryption request 401 may include the encrypted data, and/or the identification token.

In some embodiments, all wallet API users' private keys are stored encrypted with a key managed by an HSM, and only a wallet API server (i.e., the wallet backend server 409) is able to decrypt the keys inside of the TEE 410. Cloud audit logs may also be used as proof that the key access policy has not been modified in any way (e.g., by a node operator).

The wallet backend server 409 may have several components. A token validation module 412 validates the ID token from the decryption request 401. An access policy validation module 414 validates that the authenticated ID token has permission to access decrypted data. A data decryption module 416 decrypts the encrypted data (e.g., using ECIES), using the auditor group private key 418. The auditor group private key 418 is an encrypted key and is stored in an encrypted private key storage 420. Accordingly, the data decryption module 416 also decrypts the encrypted private key 418 after retrieval from the encrypted private key storage 420. For security, private keys may only be decrypted in the TEE 410. The decrypted data 429 is then returned to the user.

In some embodiments, the access policy validation module 414 validates that the requester is an auditor, e.g., a member of the trusted auditor group. In some embodiments, the access policy validation module 414 validates that the requester is a validator node 312. In some embodiments, validator nodes 312 are able to sign decryption requests using JWT tokens signed with an HSM-managed private key. In the example of FIG. 4, the public key has been whitelisted in the wallet backend server 409. Additionally, the wallet backend server 409 may apply IP address filtering to ensure that the decryption request 401 is from a registered validator node 312.

In some embodiments, only a small number of admin users are able to manage users (e.g., add or remove users) from the auditor access list. The Wallet API (e.g., wallet backend server 409) may store the access list directly, not rely on any type of external service, and only accept the list that is signed by a predetermined public key.

In some embodiments, an admin user manages the corresponding private key and can implement it in different ways, including but not limited to:
1. The private key may be managed in a separate account by an HSM.
2. The private key may be managed using a hardware device belonging specifically to the admin user.
3. The private key may be managed by the Wallet API (e.g., backend server 409) with an additional 2FA authentication policy.

Some embodiments provide a digital wallet that is non-custodial and handles the key split in secure process by utilizing (1) a hardened, physically separated cloud storage, and (2) the user's device. This allows for a streamlined experience without exposing users to any of the elements of blockchain technology. Such embodiments are suited for a myriad of applications ranging from access, subscriptions, and loyalty, to institutional use cases, including Know Your Customer (KYC) and anti-money laundering (AML) compliance.

Some embodiments enable only verified, approved users to log in to any system without the risks associated with traditional username and password credentials. Data may be encrypted and decrypted internally without requiring instances outside of the secure environment. This function may be useful for clients to utilize a zero-knowledge data suite, where every user interaction is stored as an encrypted data point within the wallet. Clients may query this verified, encrypted data through an artificial intelligence (AI) engine to gain insights while custody is retained by the end user.

Some embodiments provide an isolated, secure decrypt/encrypt environment, which can be used in any capacity to transfer sensitive data to and from users.

In some embodiments, interaction data points are stored and encrypted with blockchain technology. This environment provides auditability with fully verified data points, and audit access may be granted via a secure method to any auditor, whether internal or external, and may only reveal data points relevant to their permissions.

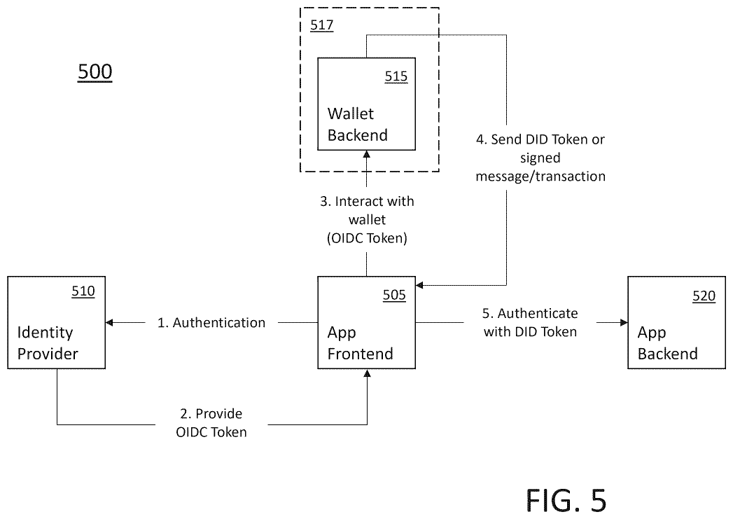

FIG. 5 is a block diagram illustrating details of a system 500 for implementing a digital wallet, according to some embodiments. The system 500 is similar to the embodiment of the system 300 and system 400 discussed above with respect to FIG. 3 and FIG. 4, respectively, or other system embodiments discussed below. A detailed description of some components of the system 500 will be omitted, and the following discussion focuses on the differences between these embodiments. Any of the various features discussed with any one of the embodiments discussed herein may also apply to and be used with any other embodiments.

The system 500 includes an application frontend 505 (e.g., executing on a user device, such as but not limited to client device 110-1), an identity provider 510, a wallet backend 515 within a TEE 517 (e.g., executing on a server, such as but not limited to a server 130-1), and an application backend 520 (e.g., executing on a server, such as but not limited to a server 130-1). The application backend 520 may execute on a different server than the wallet backend 515.

In this example, the application frontend 505 makes an authentication request to the identity provider 510. The identity provider 510 responds to the request with an identity token, such as (but not limited to) an OpenID Connect (OIDC) token.

Having authenticated using the identity provider 510, the application frontend 505 interacts with the wallet backend 515 (executing within the TEE 517) to perform a transaction and provides it the OIDC token. Examples of interactions between the application frontend 505 and the wallet backend 515 include, but are not limited to, creating a new wallet (e.g., via an HTTP API call, such as “/api/createWallet”), signing a message (e.g., via an HTTP API call, such as “/api/signMessage”), and signing a transaction (e.g., via an HTTP API call, such as “/api/signTransaction”). In response, the wallet backend 515 sends back a decentralized ID (DID) token or a signed message or transaction to the application frontend 505. The application frontend 505 uses the DID token to authenticate with the application backend 520.

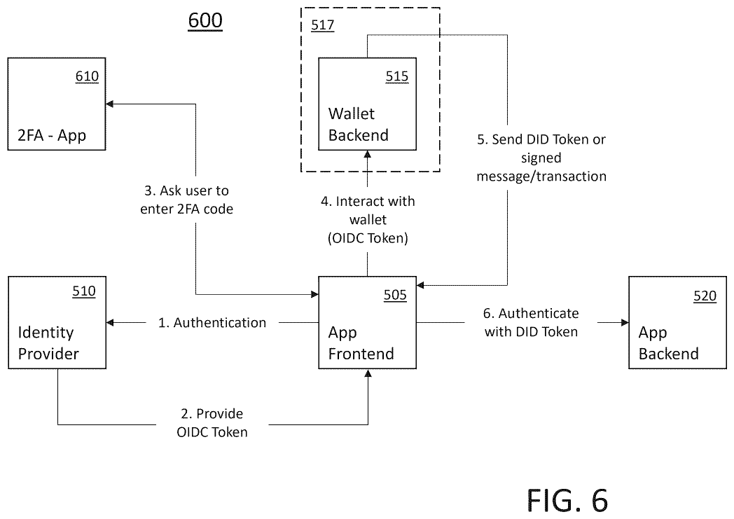

FIG. 6 is a block diagram illustrating details of a system 600 for implementing a digital wallet, according to some embodiments. The system 600 is similar to the embodiment of the system 300, system 400, and system 500 discussed above with respect to FIGS. 3-5, respectively, or other system embodiments discussed below. A detailed description of some components of the system 600 will be omitted, and the following discussion focuses on the differences between these embodiments. Any of the various features discussed with any one of the embodiments discussed herein may also apply to and be used with any other embodiments.

The system 600 includes the application frontend 505 (e.g., executing on a user device, such as but not limited to client device 110-1), the identity provider 510, the wallet backend 515 within the TEE 517 (e.g., executing on a server, such as but not limited to a server 130-1), and the application backend 520 (e.g., executing on a server, such as but not limited to a server 130-1), as discussed above with respect to FIG. 5. The system 600 further includes a two-factor authentication application 610.

In this example, the application frontend 505 makes an authentication request to the identity provider 510. The identity provider 510 responds to the request with an identity token, such as (but not limited to) an OpenID Connect (OIDC) token. The application frontend 505 further asks the user to enter a two-factor authentication code, provided by the two-factor authentication application 610.

Having authenticated using both the identity provider 510 and the two-factor authentication application 610, the application frontend 505 interacts with the wallet backend 515 (executing within the TEE 517) to perform a transaction and provides it the OIDC token. Examples of interactions between the application frontend 505 and the wallet backend 515 include, but are not limited to, creating a new wallet (e.g., via an HTTP API call, such as “/api/createWallet”), signing a message (e.g., via an HTTP API call, such as “/api/signMessage”), and signing a transaction (e.g., via an HTTP API call, such as “/api/signTransaction”). In response, the wallet backend 515 sends back a decentralized ID (DID) token or a signed message or transaction to the application frontend 505. The application frontend 505 uses the DID token to authenticate with the application backend 520.

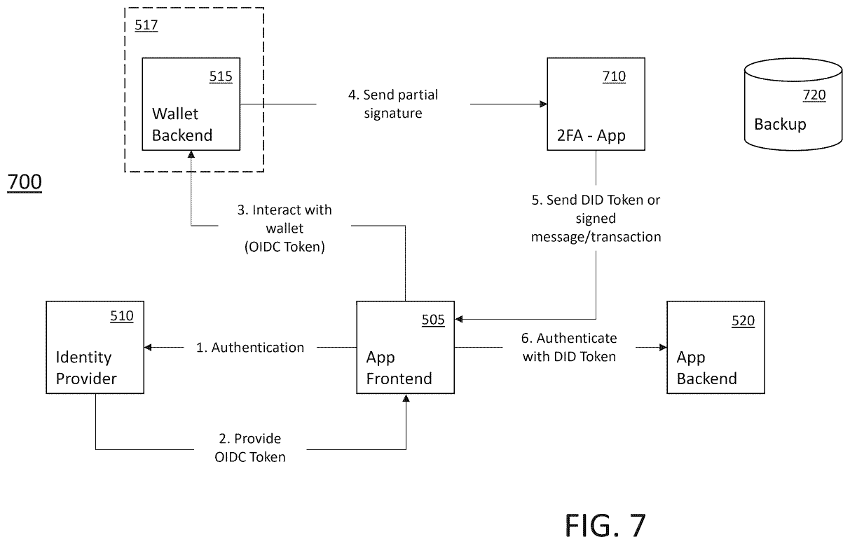

FIG. 7 is a block diagram illustrating details of a system 700 for implementing a digital wallet, according to some embodiments. The system 700 is similar to the embodiment of the system 300, system 400, system 500, and system 600 discussed above with respect to FIGS. 3-6, respectively, or other system embodiments discussed below. A detailed description of some components of the system 700 will be omitted, and the following discussion focuses on the differences between these embodiments. Any of the various features discussed with any one of the embodiments discussed herein may also apply to and be used with any other embodiments.

The system 700 includes the application frontend 505 (e.g., executing on a user device, such as but not limited to client device 110-1), the identity provider 510, the wallet backend 515 within the TEE 517 (e.g., executing on a server, such as but not limited to a server 130-1), and the application backend 520 (e.g., executing on a server, such as but not limited to a server 130-1), as discussed above with respect to FIGS. 5 and 6.

In some embodiments, the system 700 further includes a two-factor authentication application 710. The two-factor authentication application 710 may contain a client share in a keychain provided by a third party.

In some embodiments, the system 700 further includes a backup 720. The backup 720 may be used in conjunction with a server share or a client share to recover the wallet.

In this example, the application frontend 505 makes an authentication request to the identity provider 510. The identity provider 510 responds to the request with an identity token, such as (but not limited to) an OpenID Connect (OIDC) token.

Having authenticated using the identity provider 510, the application frontend 505 interacts with the wallet backend 515 (executing within the TEE 517) to perform a transaction and provides it the OIDC token. Examples of interactions between the application frontend 505 and the wallet backend 515 include, but are not limited to, decrypting data, creating a new wallet, and signing a message or a transaction. In response, the wallet backend 515 sends a partial signature to the two-factor authentication application 710, and in response, the two-factor authentication application 710 sends back a decentralized ID (DID) token or a signed message or transaction to the application frontend 505. The application frontend 505 uses the DID token to authenticate with the application backend 520.

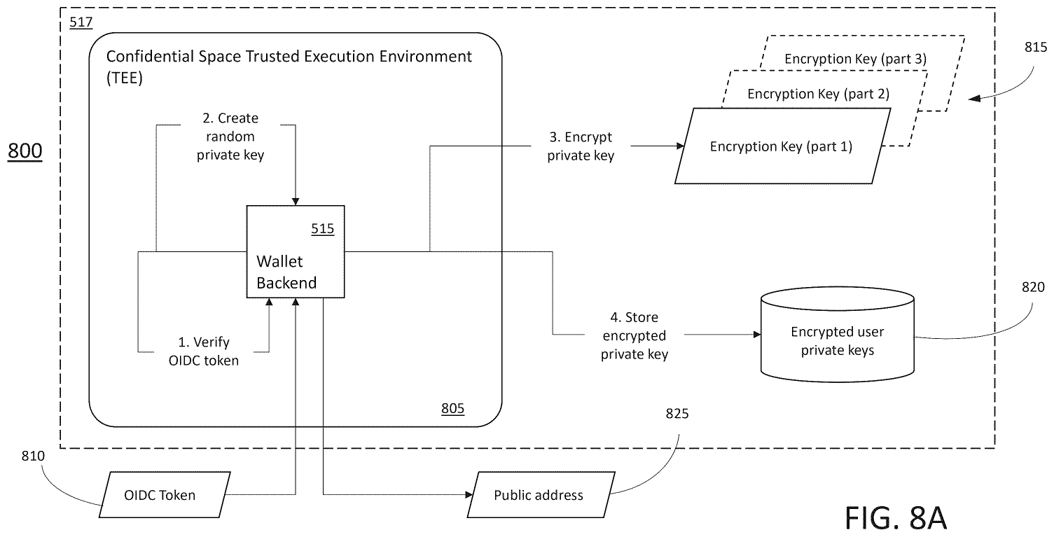

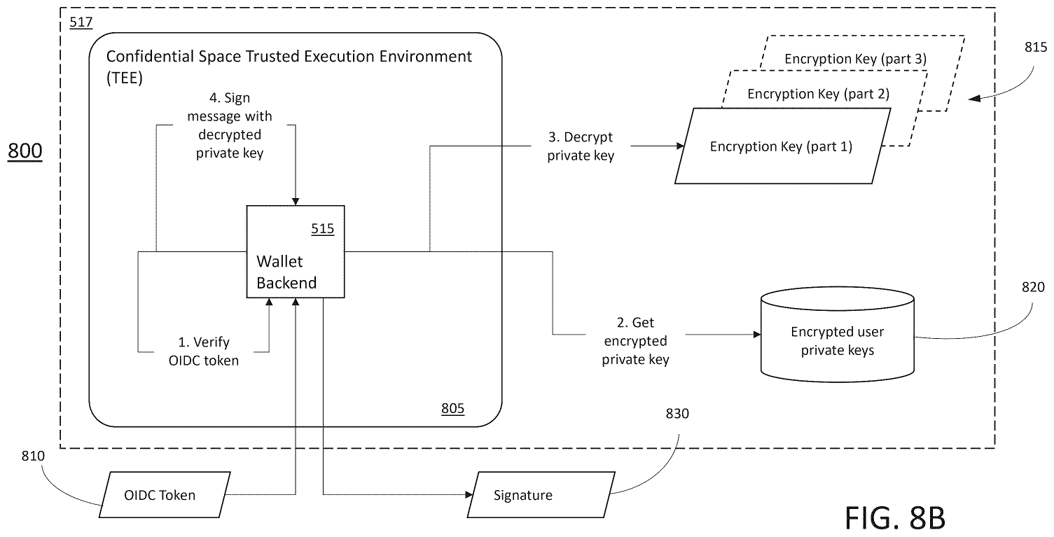

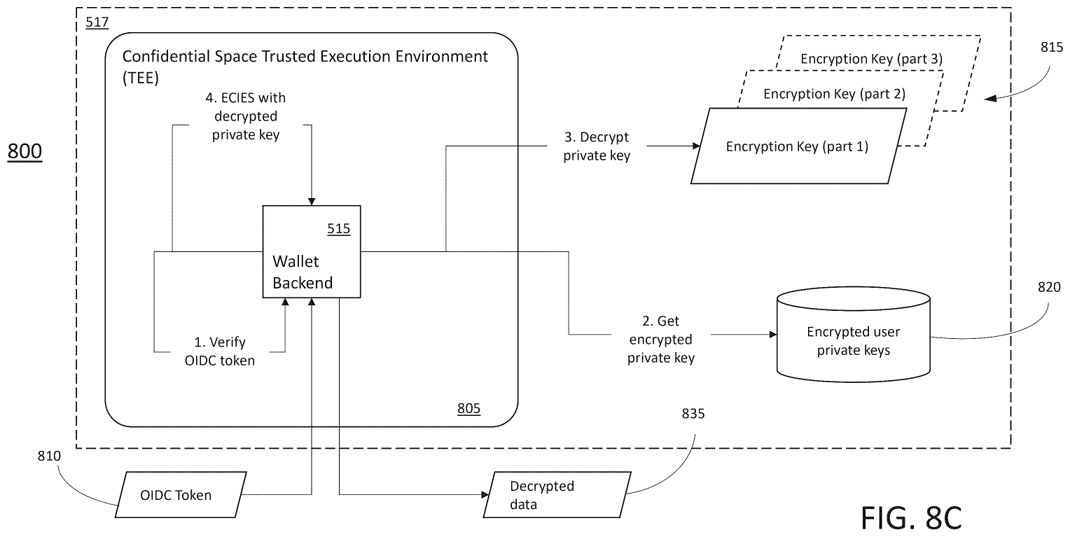

FIGS. 8A-8C show details of how a wallet backend of some embodiments responds to different encrypted transaction requests. The wallet in this example is the digital wallet backend 515 executing within the TEE 517 as described above with respect to the embodiments of FIGS. 5-7. In other embodiments, a different digital wallet may be used.

FIG. 8A shows an example of a digital wallet 800 responding to a wallet creation request. The request may be received, for example, via an HTTP API call, such as “/api/createWallet”. As part of the request, the wallet backend 515 receives an OIDC token 810 (e.g., from an application, including but not limited to application frontend 505 discussed above). The wallet backend 515 verifies the OIDC token, creates a random private key, and encrypts it. The key may be stored as multiple key parts 815. The encrypted private key is stored in an encrypted storage 820. The wallet backend 515 then provides the wallet public address 825 in response to the wallet creation request.

FIG. 8B shows an example of a digital wallet 800 responding to a signature request (e.g., for a message, a transaction, etc.). The request may be received, for example, via an HTTP API call, such as “/api/signMessage” or “/api/signTransaction.” As part of the request, the wallet backend 515 receives an OIDC token 810 (e.g., from an application, including but not limited to application frontend 505 discussed above), and verifies it. The wallet backend 515 retrieves an encrypted private key from the encrypted storage 820 and decrypts the private key (or parts thereof from the encrypted key parts 815). The wallet backend signs the message (or transaction, or other data requested to be signed) using the decrypted private key and provides the signature 830 in response to the signature request. The wallet backend 515 may further propagate the signed message (or transaction, or other data to be signed).

FIG. 8C shows an example of a digital wallet 800 responding to a decryption request (e.g., for a transaction, a key, etc.). The request may be received, for example, via an HTTP API call, such as “/api/decrypt.” As part of the request, the wallet backend 515 receives an OIDC token 810 (e.g., from an application, including but not limited to application frontend 505 discussed above), and verifies it. The wallet backend 515 retrieves an encrypted private key from the encrypted storage 820 and decrypts the private key (or parts thereof from the encrypted key parts 815). The wallet backend decrypts the message (or transaction, or other data requested to be decrypted) using the decrypted private key and provides the decrypted data 835 in response to the decryption request.

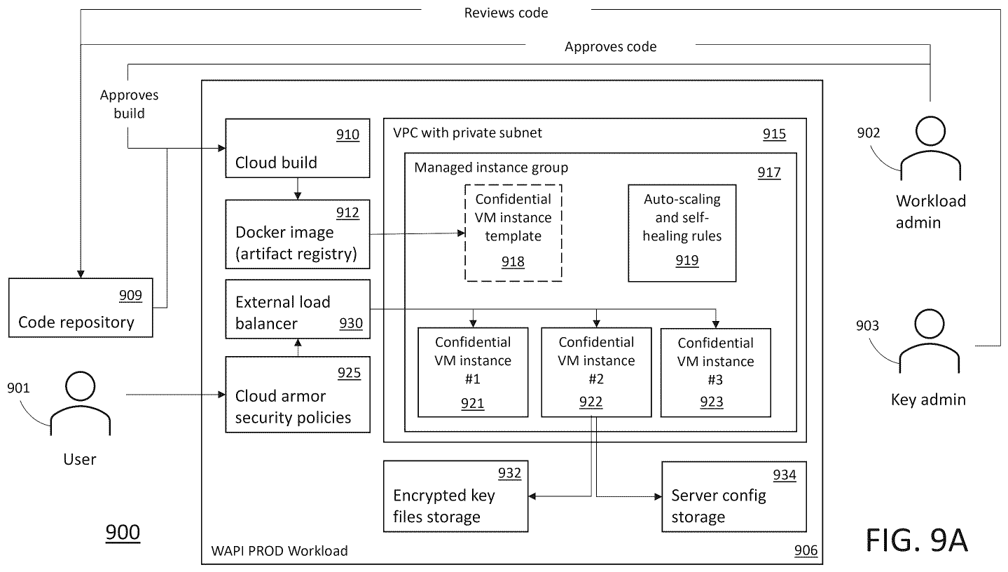

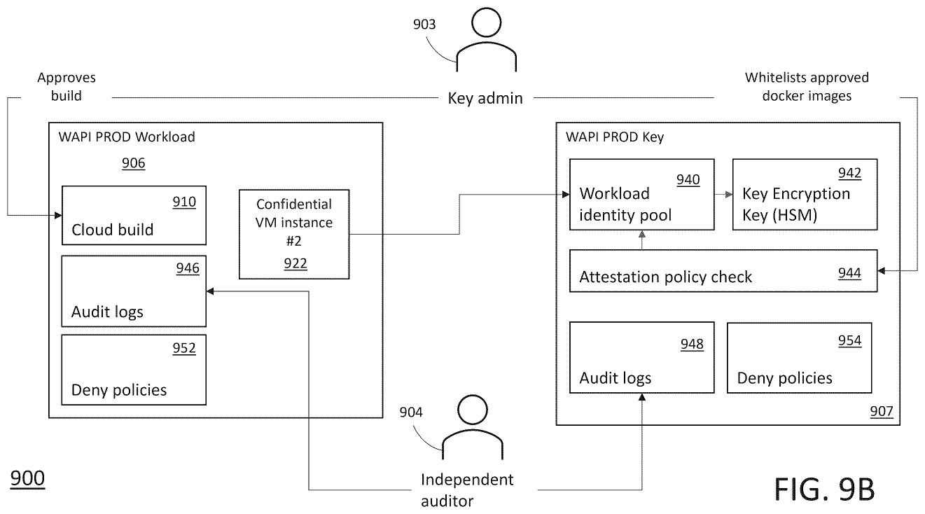

FIGS. 9A and 9B show a block diagram illustrating details of a digital wallet API 900 for encrypted transactions, according to some embodiments. The wallet API 900 is accessed and/or managed by various entities, including a user 901, a workload admin 902, a key admin 903, and an independent auditor 904. The wallet API 900 is implemented by a WAPI product workload 906 and a WAPI product key 907. A code repository 909 stores code to define the wallet API, and the code stored therein is reviewed by the key admin 903 and approved by the workload admin 902. The WAPI product workload 906 includes a cloud build 910, which is used to create a container image 912, and a VPC 915 (virtual private cloud) with a private subnet. The cloud build 910 is approved by the workload admin 902. A managed instance group 917 executes within the VPC 915 and features a confidential VM instance template 918 (denoted by a dashed line) that is configured by the container image 912. The managed instance group 917 also includes auto-scaling and self-healing rules 919. The managed instance group 917 includes several confidential VM instances 921, 922, 923 that were instantiated using the VM instance template 918.

The user 901 interacts with the API via cloud armor security policies 925 and an external load balancer 930, that assigns the user to one of the confidential cloud instances (in this example, VM instance 922). The assigned VM instance 922 also has access to an encrypted key files storage bucket 932 and a server config storage bucket 934 as needed.

The WAPI product key 907 includes a workload identity pool 940, a key encryption key module 942, and an attestation policy check 944. The key admin 903 whitelists approved container images for the attestation policy check 944.

The independent auditor 904 accesses audit logs 946 at the WAPI product workload 906 and audit logs 948 at the WAPI product key 907. The WAPI product workload 906 and the WAPI product key 907 each also include deny policies 952 and deny policies 954, respectively.

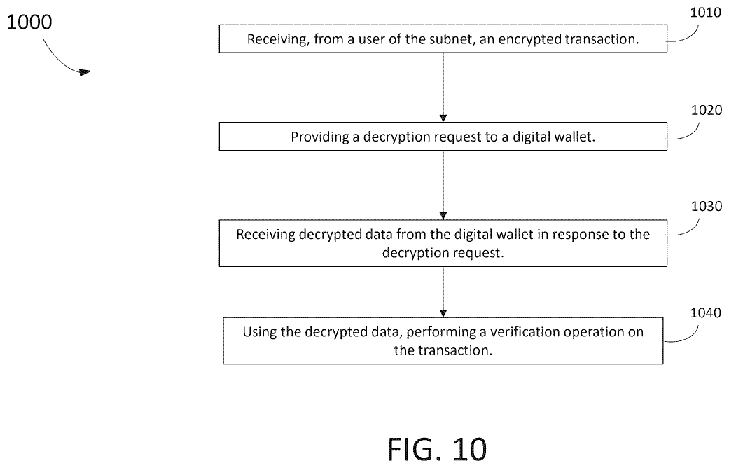

FIG. 10 is a flowchart illustrating a process 1000 for verifying transactions in a subnet performed by a validator node of the subnet (e.g., server 130-1, etc.), according to some embodiments. In some embodiments, the validator node is deployed in a trusted execution environment such that the operator of the node does not have access to transaction data of the validator node.

In some embodiments, one or more operations in process 1000 may be performed by a processor circuit (e.g., processors 205, etc.) executing instructions stored in a memory circuit (e.g., memories 207, etc.) of a system (e.g., system 200, system 300, system 400, system 500, system 600, system 700, etc.) as disclosed herein. For example, operations in process 1000 may be performed by cryptography application 222, blockchain application 223, cryptography engine 232, blockchain engine 233, or some combination thereof. Moreover, in some embodiments, a process consistent with this disclosure may include at least operations in process 1000 performed in a different order, simultaneously, quasi-simultaneously, or overlapping in time.

At 1010, the process 1000 receives, from a user of the subnet, an encrypted transaction that was encrypted by a public key associated with an auditor of the subnet. The encrypted transaction may include encrypted data fields as well as unencrypted metadata fields. In some embodiments, the transaction may be an event from a smart contract.

In some embodiments, the process 1000 determines whether the user has permission to conduct transactions on the subnet. If the user does not have permission to conduct transactions, then the transaction may be discarded. If the user does have permission to conduct transactions, then the process 1000 continues to 1020, which is described below.

In some embodiments, the encrypted transaction is received from the user via an application executing on a user device, and the transaction was encrypted on the user device.

In some embodiments, the encrypted transaction is stored in a protected memory area of the validator node upon receipt (e.g., prior to decryption and verification operations discussed below).

At 1020, the process 1000 provides a decryption request to a digital wallet, the request including encrypted data from the transaction. In some embodiments, the validator node uses an application programming interface of the digital wallet to provide the decryption request to the digital wallet.

At 1030, the process 1000 receives decrypted data from the digital wallet in response to the decryption request.

At 1040, the process 1000 uses the decrypted data to perform a verification operation on the transaction. In some embodiments, based on a determination that the transaction is valid, the process 1000 adds the encrypted transaction to a block of a blockchain. In some embodiments, the process 1000 deletes the encrypted transaction from the protected memory area after performing the verification operation.

In some embodiments, the process 1000 further receives a query for log data and/or other data associated with the encrypted transaction. The process 1000 encrypts the requested data using the public key associated with the auditor of the subnet, and provides the encrypted data in response to the query.

Some embodiments provide a user account system for decentralized, anonymized identity authentication. For example, in some embodiments, Anonymized Decentralized Identity (ADI) Tokens are provided which may be, for example, JWT Identity Tokens compatible with existing standards such as the OpenID Connect (OIDC) standard.

In some embodiments, ADI tokens may be used in any existing application that supports OIDC (for example single sign on, abbreviated as SSO).

In some embodiments, Security Assertion Markup Language (SAML) assertions may be created in order to provide SSO compatibility with SAML enabled service providers.

In some embodiments, ADI tokens may be issued on the basis of decentralized ID (DID) tokens that are issued by a digital wallet, including but not limited to the embodiments described above with reference to FIGS. 5-7, 8A-8C, 9A-9B, and 10.

### DID Tokens

In some embodiments, tokens may be issued from a Wallet API service, such as but not limited to the examples discussed above with respect to FIGS. 8A-8C and 9A-9B. Examples of techniques to create DID tokens include (presented in order of increasing security):

A DID token based on a proof that the user owns a particular email address.

A DID token based on a proof that the user owns a particular email address and provides a valid 2FA code (hash-based one-time passwords, e.g., HOTP, time-based one-time passwords, e.g., TOTP, application programming interfaces, e.g., WebAuthn, and the like).

A DID token based on a combined signature from two separate key shards using multi-party computation, e.g., MPC (for example, an email-based proof and a mobile device).

In some embodiments, a DID token contains information about the user's email address, public wallet address, and the ID of the client for which the token is created. This claim may be signed with the private key of the user corresponding to the wallet address, which allows it to be independently verified.

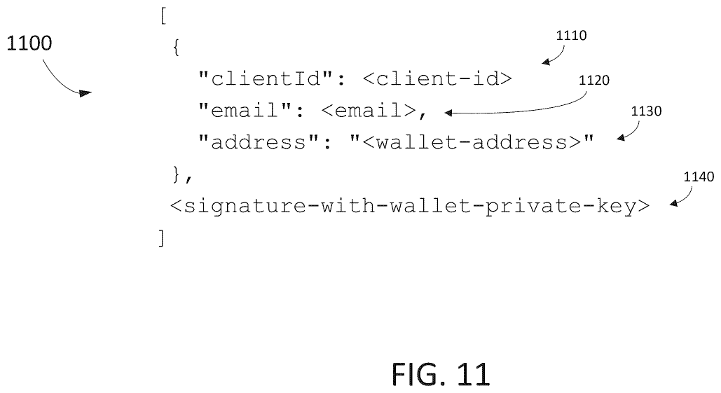

FIG. 11 shows an example of a DID token 1100 according to some embodiments. The DID token 1100 includes a field 1110 for client ID, a field 1120 for the user's email, a field 1130 for the user's public wallet address, and a field 1140 with the signature.

### Token Content

In some embodiments, the ADI token content is derived from a DID token. In the example of a JSON Web (JWT) ID Token, ADI tokens may support all required fields with some specific rules applied to some of them.

### Audience

The term “audience” as used herein is defined as who the token is intended for. In the case of ADI tokens, this may mean that only the holder of the audience private key will be able to have full access to the token content. Possible applications of this concept in some embodiments are discussed below.

In some embodiments, the audience is defined as the public key that will be used to encrypt the data.

### Subject

In some embodiments, the subject field is a unique identifier of the user that has requested the token. As an example, the user ID may be computed as:

$$sub = asymmetric\_encrypt ( < did - token > , < audience - public - key > )$$

In some embodiments, the DID token of the user obtained after login is encrypted with the public key of the audience that is intended to be able to decrypt it. As a result, the token is essentially anonymous for all other parties, except the holder of the audience private key. It is also a unique identifier of the user.

### Email

A goal of the ADI tokens of some embodiments is to ensure the privacy of the user (for example, if the emails are leaked from a service provider's database). This means that the email address in the token needs to be private in some embodiments as well.

It may not be ideal to use the same method to define the email as is done for the subject as described above, since due to the limitations of the size of email addresses, the subject would be too long. Therefore, some embodiments use the following format:

$$email = sha256 ( < sub > ) @ domain . com$$

where “domain.com” may be any Internet domain or network domain.

In this example, the SHA256 hash of the subject is used as the part of the email before the @ symbol, which is 64 characters long and therefore complies with the requirements for the email address size. The mapping from the hash to the subject is unique and can be public as the real information is stored encrypted in the subject itself.

Alternatively, if some identity information needs to be provided with the token, the email may be defined in other embodiments as follows:

$$email = < name > @ sha256 ( < sub > ) . domain . com$$

In this case, the user's alias is exposed, but not their original email.

### Token Signature

In some embodiments, JWT tokens may be signed with a public/private key pair, for which the public key may be published on the issuer's public JSON Web Key Set (JWKS) URL. For example, some embodiments use the ECDSA-256 signing algorithm on the P-256 curve that is officially supported by the JWT standard. An Elliptic Curve signature algorithm may be used in some embodiments due to the smaller size of the keys.

Two examples of ways to sign ADI tokens are discussed below, namely, using the user's own private key and using a set of master keys.

### Signing ADI Tokens with the User's Private Key

The benefits of using the user's own private key to sign the ADI token include removing the need of having master keys for the token signature. This may provide an increase in security as a compromised private key will allow the attacker to only impersonate one specific user and not all users.

The challenge is how to provide the public keys of all users (e.g., on a static JSON Web Key Set, or JWKS, URL). In a small organization, it may be feasible to publish all public keys directly on a JWKS URL (given the small size of the EC key). For larger organizations, the content of the JWKS URL may be dynamically updated to only include the public keys of users that have a non-expired token created. By controlling the expiration time of the tokens, the size of the list may be reduced or decreased.

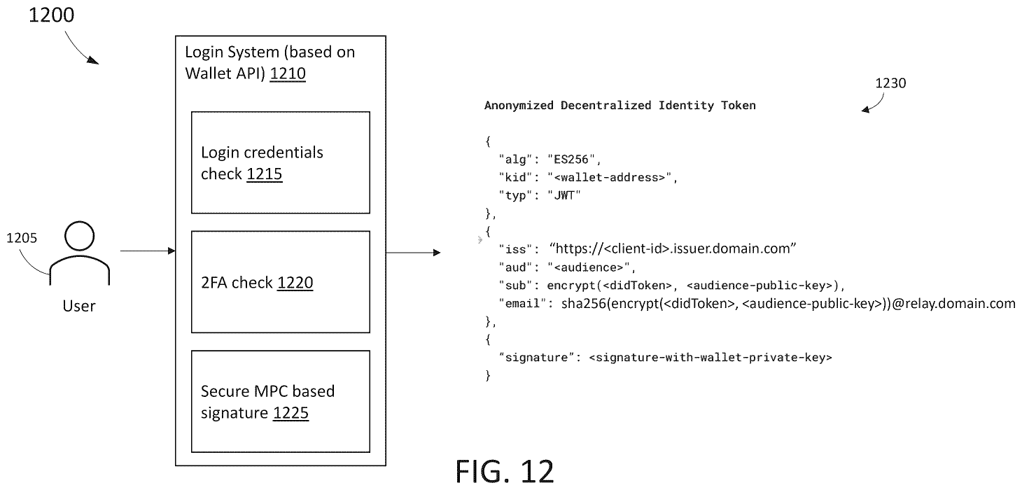

FIG. 12 shows an example 1200 of a signature using individual private keys, according to some embodiments. A user 1205 attempts to log in using a login system 1210 that utilizes a Wallet API service, such as but not limited to the examples discussed above with respect to FIGS. 8A-8C and 9A-9B. The login system 1210 performs a login credentials check 1215 and a 2-factor authentication (2FA) check 1220 and generates a secure Multi Party Computation (MPC) based signature 1225. The login system 1210 then creates an anonymized decentralized identity token 1230.

### Signing ADI Tokens with a Combined Master Key

For very large organizations, some embodiments convert DID tokens to ADI tokens which can be signed. This may be performed, for example, by a separate software module. To achieve a very high level of security, two or more keys may be used for the signature. Each of the keys creates a partial signature, and the signatures are then combined into the final one using MPC. Access to the keys may only be given to a pre-approved workload version running in a Trusted Execution Environment (e.g., as described above in embodiments of a Wallet API with respect to FIGS. 8A-8C and 9A-9B).

Additionally, large organizations may want to take custody of one of the master keys. Since the JWT signer code is very simple, the software version may not need to be updated on a regular basis, so management overhead may be small.

In some embodiments, the communication channel between the Wallet API and the JWT Signer is encrypted and confined to a private subnet or in some cases running on the same virtual machine in the same TEE. In this manner, the unencrypted DID token never leaves the system.

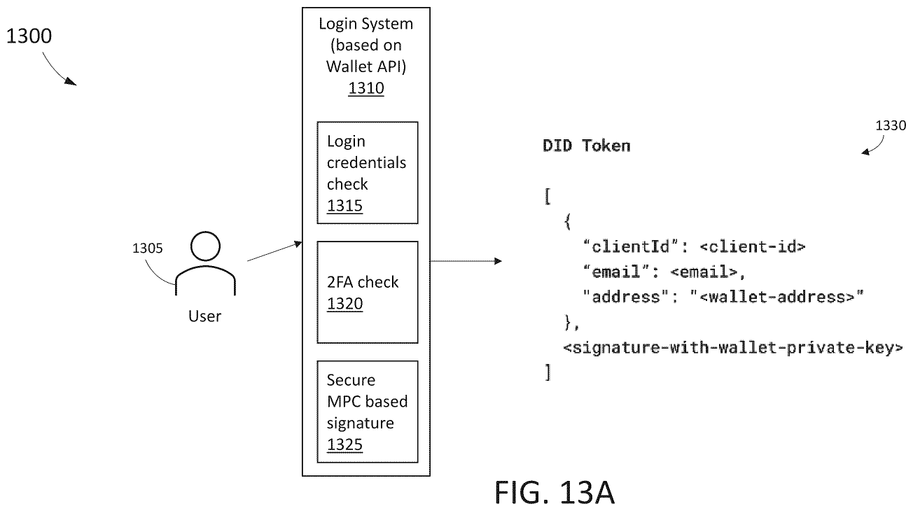

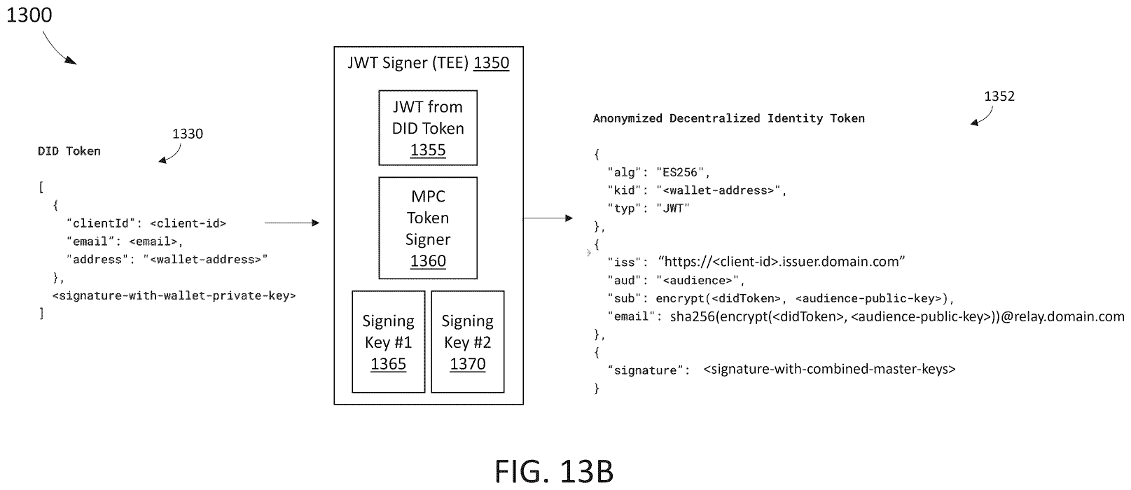

FIGS. 13A and 13B show an example 1300 of a signature using multiple master keys, according to some embodiments.

A user 1305 attempts to log in using a login system 1310 that utilizes a Wallet API service, such as but not limited to the examples discussed above with respect to FIGS. 8A-8C and 9A-9B. The login system 1310 performs a login credentials check 1315 and a 2-factor authentication (2FA) check 1320 and generates a secure Multi Party Computation (MPC) based signature 1325. The login system 1310 then creates a decentralized identity (DID) token 1330.

The DID token 1330 is provided to a JWT signer 1350 executing in a TEE (omitted for clarity). The JWT signer 1350 creates a JWT 1355 from the DID token 1330, and performs multi-party computation using a Token Signer 1360 upon at least two signing keys (in this example, signing key #1 1365 and signing key #2 1370). The JWT signer 1350 then generates an anonymized decentralized identity token 1352.

### Use-Cases for ADI Tokens

ADI tokens may be utilized in various embodiments for many use-cases, depending on how the audience is selected. Some non-limiting examples are discussed below.

### Private Email Relay

If an ADI token is used for an SSO connection with a service provider, the email may be important, as service providers often need to communicate per email with the users. For example, a web vendor or marketplace may need to send purchase confirmation emails. In some embodiments, a Login System (e.g., login system 1210 or login system 1310) uses the audience of a Private Email Relay that is part of the Login System. The Private Email Relay holds the private key that can be used to decrypt the content of the subject and forward the email to the real email address of the user. The Email Relay may also be running in a TEE, so all data stays encrypted at rest, in transit, and in use. At the same time, the service provider is able to communicate with the users, without knowing their real email addresses.

The Private Email Relay is simple and secure as it doesn't need to maintain a mapping from private identifiers to the real user's email. This means the attack vector for forwarding emails to the wrong user is very small and essentially requires breaking the asymmetric encryption.

### Web Applications Storing User Data

Another use-case of some embodiments may be in web applications that store data related to the user. Using ADI tokens enables the user's identity to be stored in an encrypted form. Additionally, the encryption and decryption capability of a Wallet API (e.g., the examples discussed above with respect to FIGS. 8A-8C and 9A-9B) means that other data can be encrypted in the same manner as well, like for example postal addresses, purchase data, financial information, healthcare data, etc.

The audience selection provides different options. The public key of a particular admin may be used, or the public key of a group of admins may be used so only they have the ability to audit the data and see the true identity of the user. This improves security as it minimizes the attack surface. For example, DevOps admins will not be able to access the data.

In some embodiments, another mechanism is to encrypt the data for a key that is programmatically controlled by a workload running in a TEE. This means that scripts to process and analyze the data can be run in the TEE ensuring that data stays encrypted in use as well and is never exposed in an unencrypted form, while still usable for the organization. This may be applicable for sensitive financial or healthcare information.

### Client Side Encryption

In some embodiments, the login system can also be configured to use the user's own public key for the encryption. In this case, the audience becomes the user themselves and only they can decrypt the information. This functionality may be combined with the ability of a Wallet API (e.g., the examples discussed above with respect to FIGS. 8A-8C and 9A-9B) to encrypt and decrypt additional data. This ability enables applications where the user is able to fully utilize their data in an unencrypted form on the frontend of the app and then encrypt it before storing it on the application server. When the user comes back, they can download the data from the server, decrypt it and continue using it. In this way, only the user has the ability to use their own data. If the user chooses so, they can encrypt the data or some part of it and provide it to another audience.

### Secure Containers

Some embodiments provide secure containers that are able to run sensitive data processing with all inputs and outputs being encrypted. This is important for artificial intelligence, machine learning, and/or neural net models that use sensitive data (for example in the context of Retrieval Augmented Generation) or are trained on sensitive data. Additionally, some embodiments offer a dedicated access control mechanism backed by encryption.

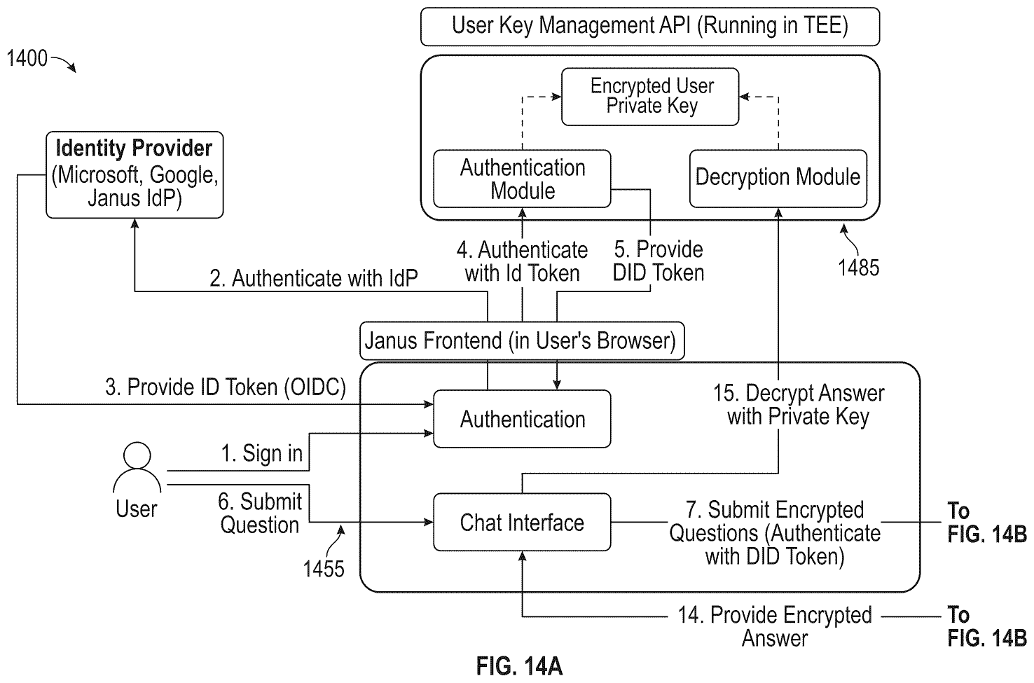

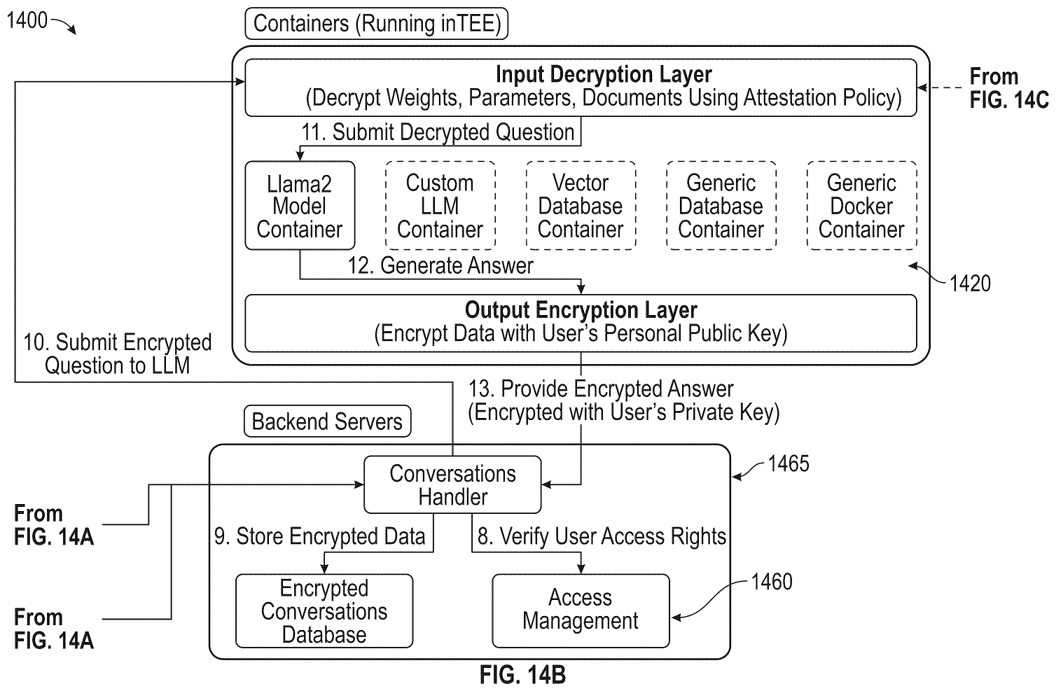

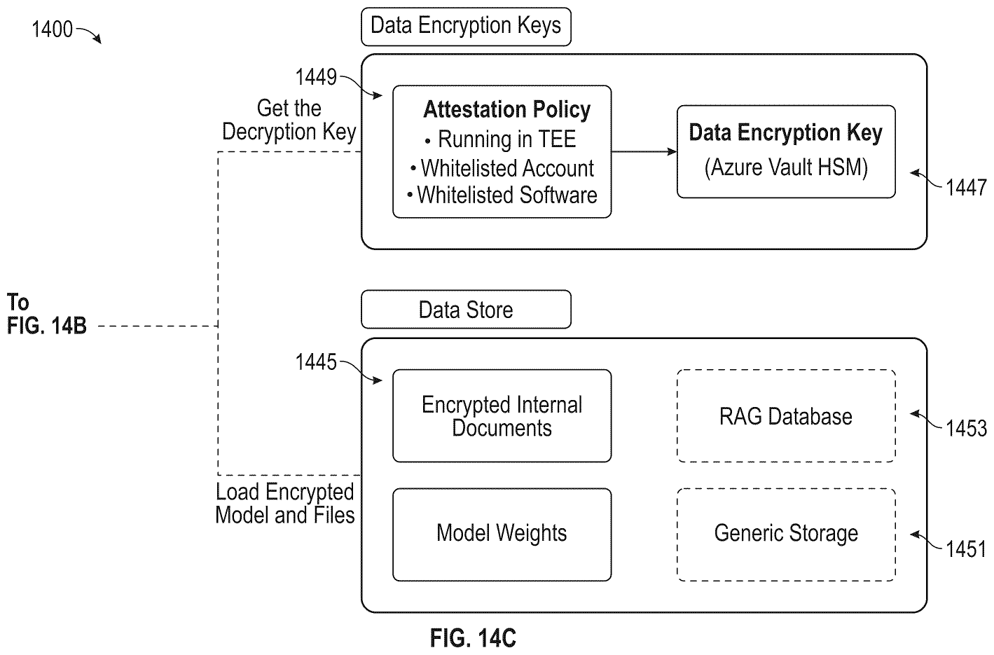

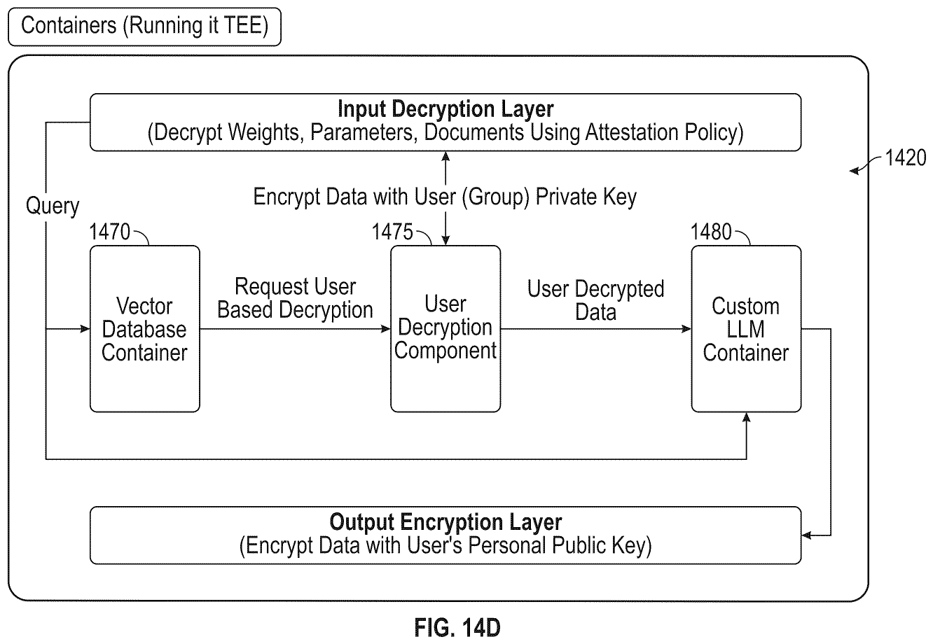

FIGS. 14A-14D are a block diagram illustrating a system 1400 for implementing secure containers, according to some embodiments. The system 1400 is similar to other embodiments described in more detail below. Any of the various features discussed with any one of the embodiments discussed herein may also apply to and be used with any other embodiments.

### Secure Containers Encryption

In various embodiments, secure containers 1420 may be used to run AI models, vector databases, regular SQL or NoSQL databases, or generic applications in a secure, encrypted and private environment.

### Trusted Execution Environments

In some embodiments, secure containers 1420 may be deployed in confidential VMs and always run in a Trusted Execution Environment (secure enclave). This means that the operator of the VM has no way to inspect the content of the machine as the memory is encrypted.

### Encrypted Input

Running the code in a TEE may not be enough to guarantee the privacy of all data. For this, in some embodiments, both the inputs to the container as well as the outputs are encrypted. At least two types of inputs may be considered, common and user inputs.

Common inputs 1445 are data blocks that are used independent of the user. For example, in some embodiments, this can be the weights of an AI model, important documents provided as context to an LLM, database storage or other types of application storage.

In some embodiments, common inputs may be encrypted with a key that is managed in a secure HSM 1447 by another party (the owner of the data). The key may be accessible only through an attestation policy 1449 that verifies that the requester is running in a TEE, is run by a whitelisted operator, and is running a whitelisted software version. The files themselves can be stored in regular file storage 1451 or a database 1453 as they are useless without the decryption key. They can be loaded and decrypted only in the TEE and made available to the code running in it.

User inputs 1455 are generated by the user, for example by submitting a question to an AI assistant or an SQL query to a database. In some embodiments, the user can encrypt the input using an ephemeral public key provided by the TEE workload.

### Encrypted Outputs

After the code running in the secure container produces an output, in some embodiments it is encrypted with the public key of the user that has initiated the request. This output can, for example, be the answer from the AI agent or data retrieved from the database.

The public key of the user can be recovered from the DID token the user uses for authentication. This means that the secure container has a proof that this user is indeed the holder of the corresponding private key-through the signature in the DID token.

When the user receives the output, they can use the key management API to decrypt the data with their private key.

### Architecture

In some embodiments, the architecture of the secure containers 1420 allows workloads to be configured and deployed to a fully encrypted environment with minimal to no modifications of the existing code. Some embodiments offer the input and output encryption layers and an easy way to deploy the workload in a TEE.

### Access Control

In some embodiments, encrypting all data in transit, at rest and in use ensures that the data is handled in a privacy-preserving way. However, this may not address deciding who has access to the data, AI model or application in the first place. Some embodiments provide an access management module 1460 to help protect resources from being used on multiple levels.

### Resource-Based Access

In some embodiments, the backend 1465 has the ability to verify if a user has access to a particular resource before forwarding the request to that resource. This happens in the backend 1465, which gates access to the secure containers. Resource-based access can be configured using various access rules and policies.

### Fine-Grained Access

Sometimes a user needs to be allowed to access a resource, but not all data into it. For example, in RAG applications, some users may not be allowed to access specific documents.

Some embodiments enforce fine-grained access rules by adding a second layer of encryption. Application outputs (e.g., results from a database query) or intermediate data (e.g., documents selected by a RAG pipeline) are additionally encrypted with the public key of a user or a user group. The user is then asked to decrypt these before they become usable.

In the case of RAG, the query may be first passed through the vector database 1470 to identify the documents relevant for it. The document content itself is encrypted. Using an intermediate module 1475 (that is implemented as a LangChain component), the decryption of the document may be requested from the user group. The decrypted documents may then be provided as a context to the LLM model 1480.

### Group Management

If a resource needs to be used by multiple people, it cannot be encrypted with the public keys of all users. Instead, some embodiments use a Key Management API 1485 to assign the same private key to multiple users and also add and remove users from that group.

This means that all members of the group will be able to decrypt the protected resources. For example, an internal company LLM may have access to sensitive information about employee salaries. People from the HR department and the CEO may be allowed to access this data through a chatbot interface, but other employees may not have this access. Therefore, the salary data may be encrypted additionally with the private key of the group, consisting of the HR department and CEO only.

Some embodiments provide secure containers 1420 to allow collaboration among multiple parties, allowing enterprises to share sensitive information while maintaining complete encryption. This provides both privacy and security for organizations, so they can safely share data with approved processors within a Trusted Execution Environment (TEE). As a result, organizations can build fully encrypted, shared datasets that extend across multiple data providers, while fostering trusted partnerships.

Some embodiments utilize Trusted Execution Environments (TEEs) to provide secure processing of cloud-based workloads, ensuring encryption and protection of sensitive data.

Some embodiments provide secure communication between workloads across systems, ensuring complete confidentiality through end-to-end encryption via automated and transparent encryption coupled with robust key management practices.

Some embodiments may seamlessly protect existing workloads, such as web applications, API servers, and more, with minimal configuration adjustments. To secure a workload, it may be provided as a Docker image and the container parameters configured; in most cases, no modifications are needed, but occasional small adjustments may be necessary for data decryption from external resources via a software development kit (SDK).

Some embodiments offer a secure solution for enterprises that rely on third-party vendors or services. For example, an organization using external data analysis software can benefit from the secure containers of some embodiments, which shield them from potential threats targeting the vendor.

Another use case involves financial institutions that need to verify borrower information without compromising customer confidentiality. Secure containers 1420 may enable secure data sharing between institutions, allowing banks to assess loan requests without revealing sensitive information about individual customers.

In some embodiments, secure containers 1420 may utilize Confidential Virtual Machines (CVM) to isolate workloads within a fully encrypted environment-CVMs offer full memory encryption with minimal overhead, shielding data from both the cloud provider and internal IT resources. Accordingly, sensitive information remains encrypted at all stages: at rest, in transit, and during use.

Some embodiments encrypt all communication via an ephemeral private key, which is managed by a secure proxy inside the TEE. This may offer additional protection from internal risks such as compromised load balancers. Since encryption is handled transparently within the TEE, no workload changes are necessary. An SDK can also implement encrypted communication on other servers or devices. All responses may be automatically encrypted with the public key provided by the user's request, and the SDK may securely decrypt the information.

Benefits and advantages of the present disclosure may include but are not limited to:
Data Encryption: Security at all stages—at rest, in transit, and in use;
Complete Isolation: Workloads shielded from cloud providers and internal IT resources;
Transparent Encryption: All requests and responses are automatically encrypted and decrypted;
No Modifications Required: No workload changes necessary;
Encrypted Data Storage: Securely store encrypted information;
TEE-Based Decryption: Secure data decryption within a Trusted Execution Environment; and
Optional Software Version Pinning: Only allow pre-approved software versions to decrypt data.

Features of some embodiments may include, but are not limited to, some or all of continuous memory encryption (encryption in use), ephemeral key (TEE), permanent TEE key stored within an HSM, stateless workloads, optional input and output encryption, attestation policy and key protection, and permanent storage for workloads.

In some embodiments, a process for providing secure containers 1420 includes some or all of the following:
1. Data Encryption: Each data provider generates a unique encryption key used to securely encrypt their specific dataset, ensuring confidentiality and integrity throughout its lifecycle.
2. Data Sharing: The data provider securely shares the encrypted dataset with the designated processor. Throughout this process, sensitive information remains fully encrypted and protected.
3. Software Validation: The data processor securely shares the software to be used for processing with the data provider. This includes sharing the source code or a Docker image, accompanied by proof of the software's secure supply chain for transparency and trust.
4. Attestation Policy: Once the data provider approves the software for processing, an attestation policy is configured for the encryption key, ensuring that the key can only be used by specific, authorized versions of the software within the TEE.
5. Data Decryption: This occurs solely within a TEE, where data is processed without decryption outside of the secure environment.
6. Results Sharing: Once processing is complete, non-sensitive results can be securely shared among all participants. Alternatively, sensitive results can be re-encrypted using the data provider's encryption key and then shared individually with authorized parties, maintaining confidentiality throughout.

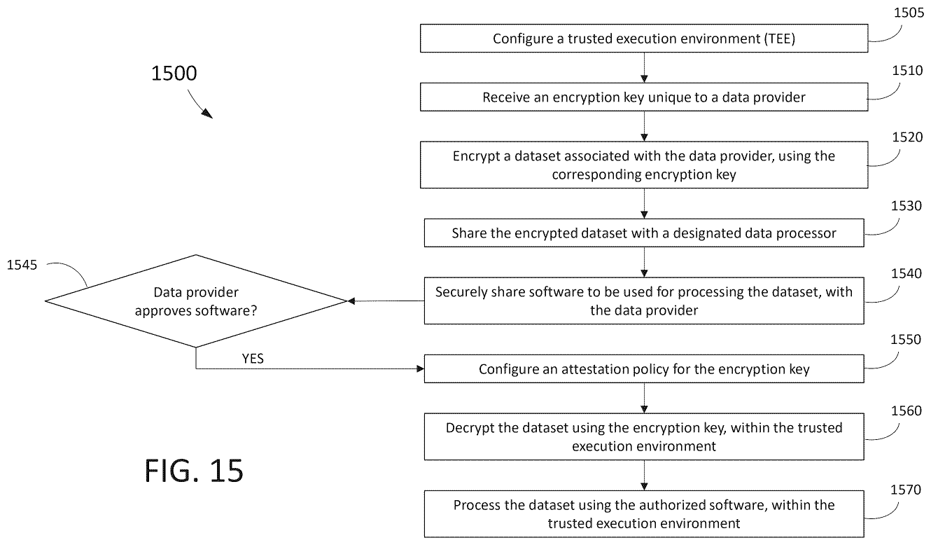

FIG. 15 is a flowchart illustrating a process 1500 for providing secure containers (e.g., secure containers 1420) performed by a confidential virtual machine (e.g., server 130-1, etc.), according to some embodiments. In some embodiments, the confidential virtual machine is deployed in a trusted execution environment such that the operator of the node does not have access to transaction data of the confidential virtual machine.

In some embodiments, one or more operations in process 1500 may be performed by a processor circuit (e.g., processors 205, etc.) executing instructions stored in a memory circuit (e.g., memories 207, etc.) of a system (e.g., system 200, etc.) as disclosed herein. For example, operations in process 1500 may be performed by cryptography application 222, blockchain application 223, cryptography engine 232, blockchain engine 233, or some combination thereof. Moreover, in some embodiments, a process consistent with this disclosure may include at least operations in process 1500 performed in a different order, simultaneously, quasi-simultaneously, or overlapping in time.

At 1505, the process 1500 configures a trusted execution environment.

At 1510, the process 1500 receives an encryption key unique to a data provider. The data provider may generate their own encryption key, or the key may be generated for them.

At 1520, the process 1500 encrypts a dataset associated with the data provider, using the corresponding encryption key.

At 1530, the process 1500 shares the encrypted dataset with a designated data processor.

At 1540, the process 1500 securely shares software to be used for processing the dataset, with the data provider. In some embodiments, the data processor provides the software to be shared with the data provider. In some embodiments, secure sharing includes sharing either source code or a software image, accompanied by proof of the software's supply chain.

At 1545, the process 1500 determines if the data provider approves the software for processing the dataset. If YES, the process 1500 continues to 1550, which is described below. If NO, the process 1500 may end.

At 1550, the process 1500 configures an attestation policy for the encryption key, to restrict use of the encryption key to the authorized software, and to further restrict use of the software within the trusted execution environment.

At 1560, the process 1500 decrypts the dataset using the encryption key, within the trusted execution environment.

At 1570, the process 1500 processes the dataset using the authorized software, within the trusted execution environment.

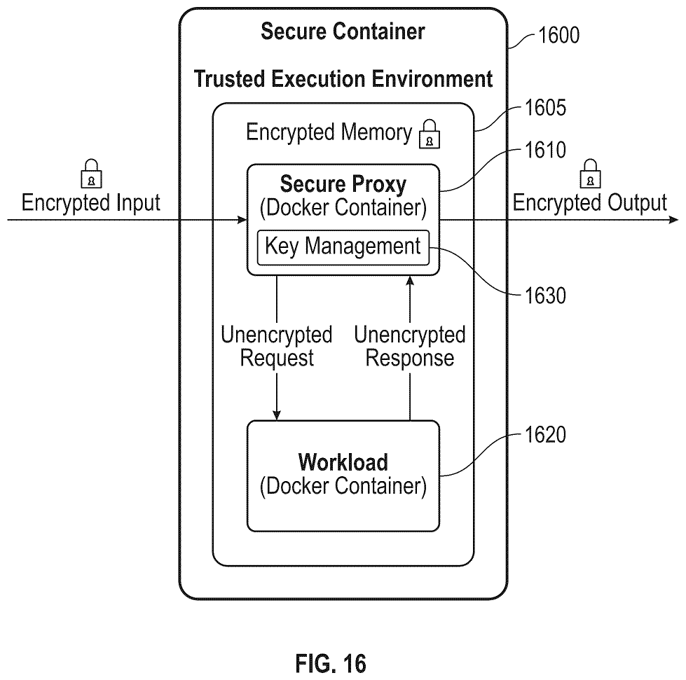

FIG. 16 illustrates an example of a secure container 1600, according to some embodiments. The secure container 1600 is similar in some respects to other embodiments discussed herein, and like reference numerals have been used to refer to the same or similar components. A detailed description of these components will be omitted, and the following discussion focuses on the differences between these embodiments. Any of the various features discussed with any one of the embodiments discussed herein may also apply to and be used with any other embodiments.

Some embodiments provide a secure container architecture that includes four components, with varying levels of necessity depending on the specific use case: (1) a Confidential Virtual Machine (CVM), (2) Secure Key Management, (3) a Secure Proxy, and (4) an SDK.

In some embodiments, secure containers are encapsulated within a Confidential Virtual Machine (CVM), which may be a type of Trusted Execution Environment (TEE) that enables computation while maintaining full encryption of its memory. This ensures that the CVM operator has no access to the contents of the machine's memory, providing complete isolation and protection for all data from unauthorized or untrusted entities.

CVMs may enable remote attestation capabilities, allowing external parties to cryptographically verify that workloads are being processed securely within the TEE, after which, the CVM configures encryption keys that can only be used within the TEE. Secure containers may automate the configuration of the client's existing infrastructure to run workloads securely within a TEE.

In the example of FIG. 16, the secure container 1600 enables the secure deployment of stateful applications within a Trusted Execution Environment (TEE) 1605, encrypting all data in transit, and isolating sensitive information from the underlying infrastructure. With the secure container 1600, users can securely store encrypted data across cloud, disk, or database storage, accessible only within the TEE.

In some embodiments, the secure container 1600 utilizes one or more Confidential Virtual Machines (CVM) to isolate Docker and/or Kubernetes workloads within a fully encrypted environment. CVMs may offer full memory encryption with minimal overhead, shielding data from both the cloud provider and internal IT resources. Accordingly, sensitive information remains encrypted at all stages: at rest, in transit, and when in use.

In some embodiments, a secure proxy plays a role in the secure container architecture, enabling end-to-end encryption between containers and external services. This provides secure communication while still allowing for transparent decryption of data within the workload.

In the example of FIG. 16, the secure proxy 1610 is an HTTP server that sits in front of the user's workload 1620, acting as a proxy for all incoming HTTP requests. It can also be configured to handle encrypted communication flows, ensuring secure data exchange between the workload and external services. The secure proxy encrypts HTTP requests with encryption to protect against exposure risks.

In some embodiments, the encryption process uses a public key provisioned on the client's infrastructure and managed within the TEE 1605 by the secure proxy. With encryption handled transparently within the TEE 1605, no workload changes are necessary.

All proxy requests may be encrypted using the secure container's public key, which can be accessed via a designated endpoint or pre-configured by the user. Similarly, the output data may be encrypted with the public key provided in the initial request, ensuring end-to-end encryption and secure communication.

In the example of FIG. 16, the secure proxy 1610 includes a key management module 1630 to securely perform both decryption of encrypted input and encryption of output, within the TEE 1605.

Some embodiments employ asymmetric encryption to facilitate secure communication with workloads within secure containers. This may involve managing a public/private key pair, where the public key encrypts messages sent to the container and the private key decrypts those messages within the TEE 1605. Key management may be tailored to meet the specific security requirements of each workload.

Ephemeral keys may be dynamically generated within the TEE 1605 at the same time as the secure container creation. These keys enable secure communication between the container and other systems, without incurring additional overhead or cost. However, ephemeral keys are regenerated each time the container restarts, making them unsuitable for encrypting data that is permanently stored within the TEE 1605.

In some embodiments, secure containers may utilize Customer Managed Encryption Keys (CMEK) for encrypting data at rest, which is commonly used to secure data stored on disks, bucket storage, or databases. This approach provides transparent encryption of permanently stored data. However, CMEKs may not provide isolation controls outside of the TEE, relying instead on trust in cloud providers and administrators to prevent unauthorized access to encrypted data.

Some embodiments provide enhanced security with secure containers that use keys stored in a Hardware Security Module (HSM). This approach may be further secured by configuring an attestation policy that restricts key usage to within a TEE only. The Key Management module automates the process of provisioning keys in the provider's Key Management Service (KMS), setting up attestation policies, and providing straightforward integration with TEE environments.

In some embodiments, when using attestation policies to encrypt data, users are responsible for managing the associated keys. However, this approach may introduce a key management challenge: super admin users within an organization may have access to both encrypted data and the decryption key. While traditional access management methods and audit logs can help mitigate risks, there is still a possibility of misuse or unauthorized access to sensitive information.

Some embodiments provide a solution to this challenge by provisioning keys to a secondary user or role, thereby separating super admins from other access roles. To simplify key management, some embodiments offer a Software-as-a-Service (SaaS)-based solution that manages keys on behalf of users. Additionally, some embodiments provide a web interface for configuring keys and attestation policies with strict access controls in place, further reducing the risk of misuse or unauthorized access.

In some embodiments, all responses may be automatically encrypted with the public key provided by the user's request, and an SDK securely and easily decrypts the information. The SDK can perform the encryption and decryption inside either a server or browser environment.

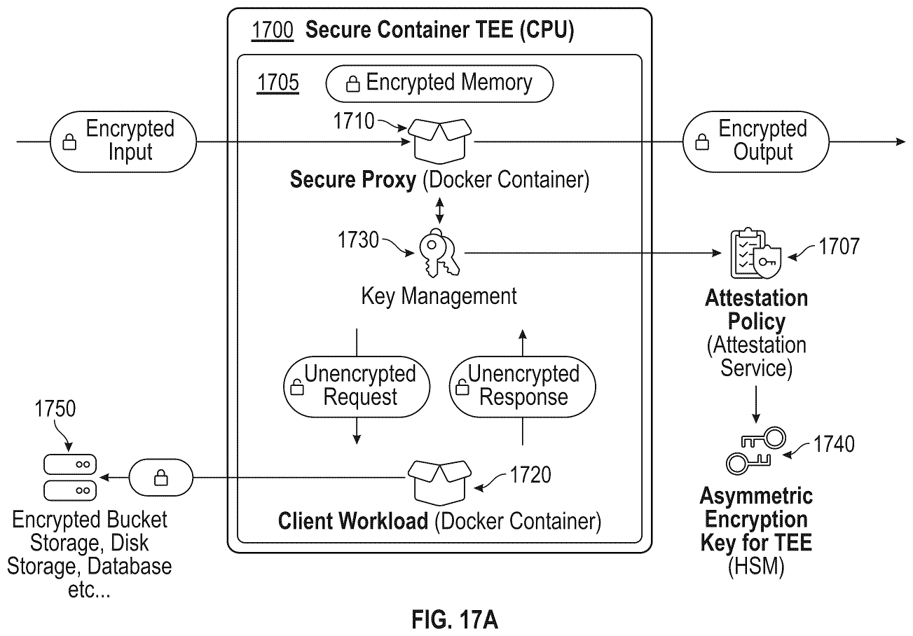

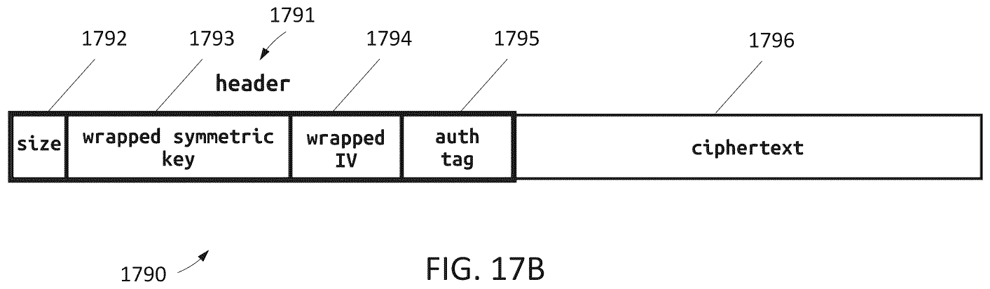

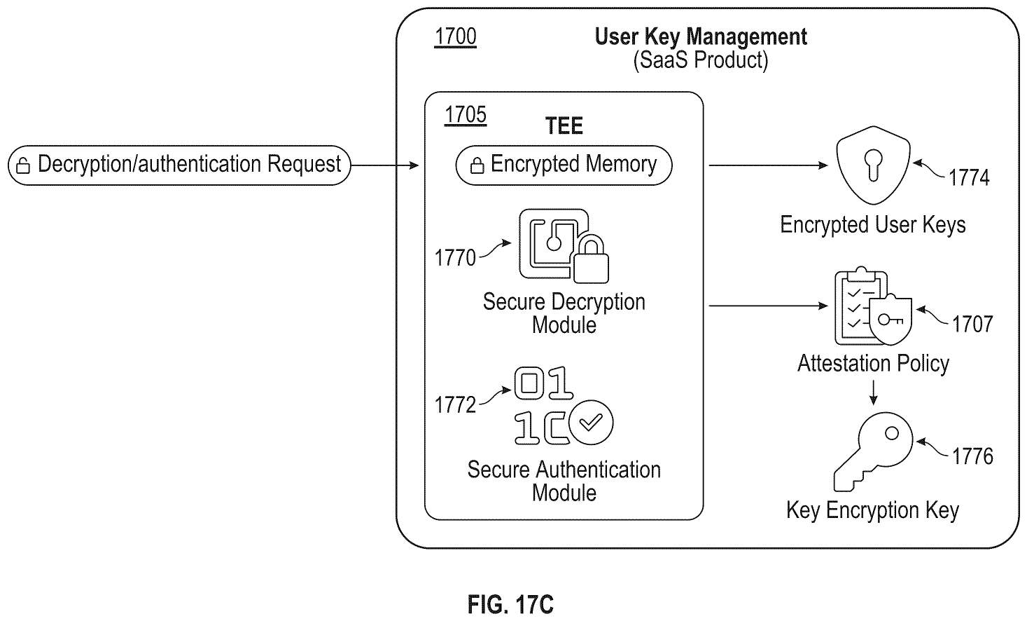

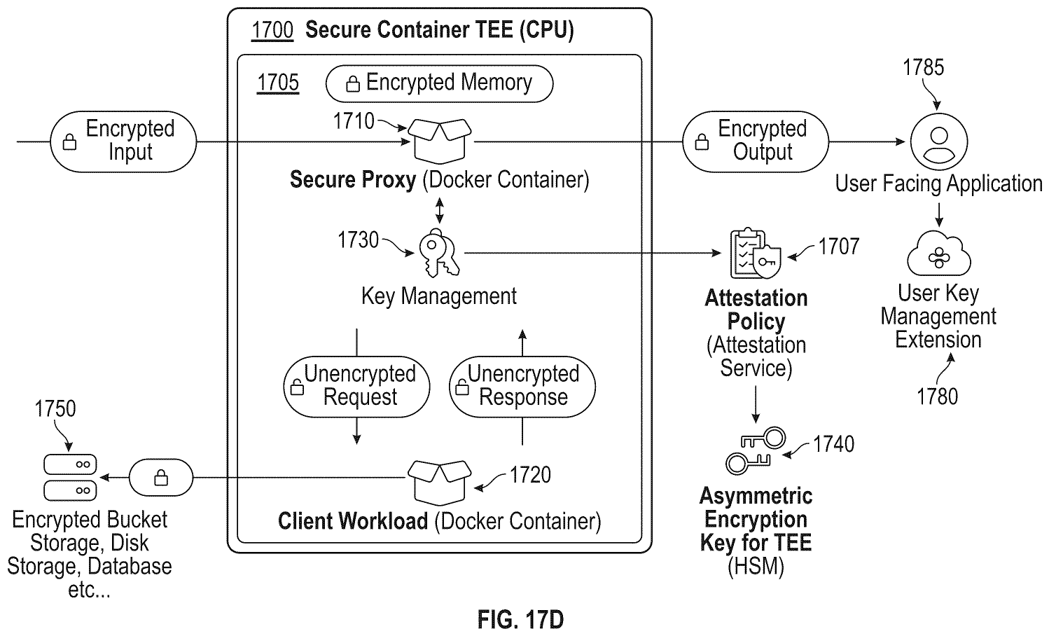

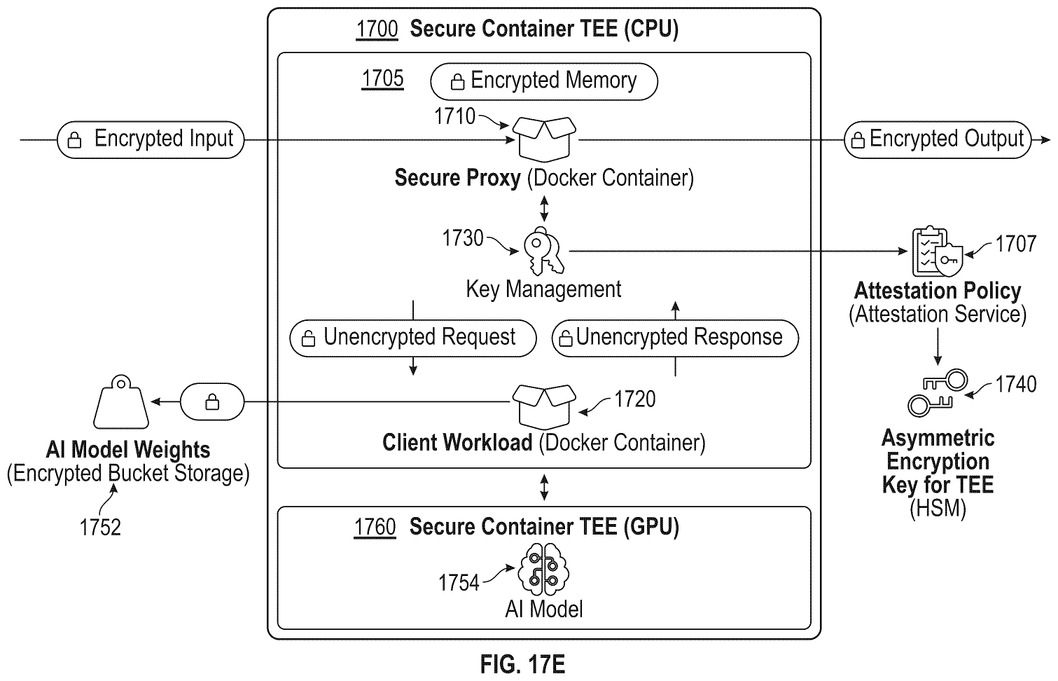

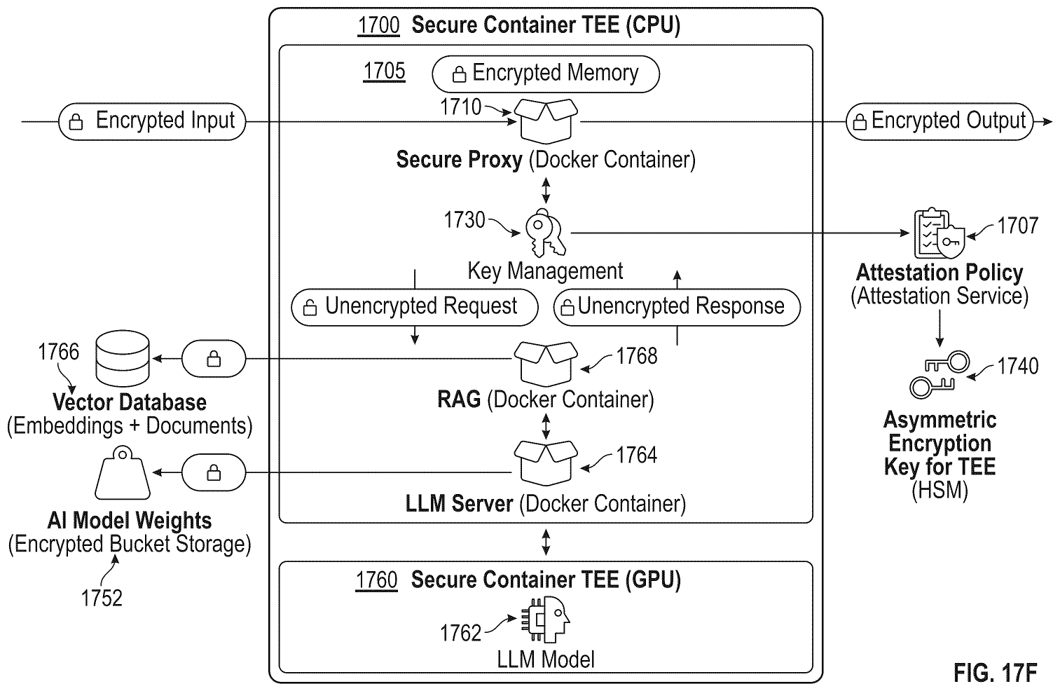

FIGS. 17A-17F illustrate another example of a secure container 1700, according to some embodiments. The secure container 1700 is similar in some respects to other embodiments discussed herein, and like reference numerals have been used to refer to the same or similar components. A detailed description of these components will be omitted, and the following discussion focuses on the differences between these embodiments. Any of the various features discussed with any one of the embodiments discussed herein may also apply to and be used with any other embodiments.

In the example of FIG. 17A, the secure container 1700 securely encrypts data across disks, cloud storage, databases, and more using a permanent key stored within the TEE 1705. Access may be restricted through an attestation policy 1707, which verifies workload integrity and can block SSH access or limit usage to pre-approved software versions. The SDK may handle both encryption and decryption for seamless data protection.

Some embodiments provide continuous encryption, securing data throughout its lifecycle by isolating existing stateful Docker workloads within the TEE 1705, shielding information from cloud providers with an option to enhance input and output encryption for increased security. Stored data may also be encrypted using a permanent key stored in a Hardware Security Module—HSM 1740, described further below—that can only be used with the TEE 1705 and allow permission-specific software version access and decryption. An external encrypted storage 1750 may be used to store encrypted output from the client workload 1720. The storage 1750 may be used for data at rest, and may be one or more of disks, bucket storage, databases, and the like.

Some embodiments facilitate migration and execution of existing workloads within the TEE 1705. By utilizing encrypted memory within the TEE 1705, some embodiments ensure that data remains fully encrypted throughout the entire processing lifecycle, thereby enhancing data security and trust.

Some embodiments provide a secure container 1700 for confidential computing to enable applications to execute within TEE 1705 isolated from the broader system, with memory encryption handled by dedicated hardware mechanisms integrated into the CPU. The encryption and decryption processes may occur transparently within the CPU, ensuring that applications remain unaffected. Consequently, the TEE 1705 may be designed to prevent even malicious administrators or hypervisors from accessing decrypted memory content.

In some embodiments, the TEE 1705 thus provides a secure means in some embodiments for processing sensitive workloads on infrastructure platforms that cannot be fully trusted, addressing critical security concerns organizations face when migrating from on-premises data centers to cloud environments.

Some embodiments use Confidential Virtual Machines (CVMs) to allow workloads to run within fully encrypted and isolated memory environments. This may streamline adoption, reduce and/or eliminate the need for application modifications, and facilitate transition of data processing workloads (e.g., using CVMs) into Trusted Execution Environments.

Having the capability to execute workloads within the TEE 1705 may not ensure end-to-end encrypted data processing. A challenge arises when workloads are executed on infrastructure provided by third parties: how can it be confirmed that the infrastructure provider has indeed enabled confidential computing capabilities on the CPU being utilized? To address this, some embodiments provide independent verification of the underlying platform's compliance with security requirements as essential, through remote attestation.

Computing providers may offer the ability to generate cryptographically signed certificates that verify the integrity and, in certain cases, specific configurations of the underlying platform. These certificates are signed using a private key embedded into the CPU during manufacturing. Verification is subsequently conducted by employing the corresponding public key issued by the chip manufacturer. Importantly, this verification process remains entirely independent of the infrastructure provider. This process establishes a chain of trust in some embodiments, beginning with the CPU manufacturer and extending to the end application, ensuring that each layer of the system adheres to defined security requirements.

In some embodiments, remote attestation is the process by which a system can prove to a remote party that it is running trusted code and has maintained its integrity. Consequently, applications should initially verify the remote attestation certificate of the workload before permitting access to sensitive data or encryption keys. Additionally, several Cloud Service Providers (CSPs) may provide services to ensure that private keys stored in HSM 1740 can exclusively be accessed by verified workloads running (e.g., as CVMs) inside TEE 1705.

With the rapid adoption of artificial intelligence applications, certain workloads necessitate confidential GPU-based computations, such as executing large language models. Although CPU memory may be encrypted, sensitive data can remain vulnerable if stored unencrypted within GPU memory or during its transfer over the PCIe bus between the CPU and GPU.

These advanced GPU security features can be seamlessly integrated, requiring no modifications to existing applications. Consequently, workloads can operate securely in a confidential computing mode when a CPU with confidential computing capabilities is paired with a compatible GPU, providing comprehensive protection for sensitive computations.

Some embodiments provide substantial solutions to address many of the security concerns faced by organizations handling sensitive data on public cloud infrastructures. However, correctly configuring these environments to avoid security gaps remains challenging. Misconfigurations can inadvertently introduce vulnerabilities, undermining the security guarantees offered by confidential computing. Some of the technology and computing problems/pitfalls that are addressed by some embodiments include:

Improper Key Attestation: Data decrypted within a Trusted Execution Environment (TEE) without correctly securing the decryption key via a stringent attestation policy. This vulnerability could allow attackers to extract and misuse the key externally, enabling unauthorized data decryption.

Insecure Internal Communications: A server positioned behind a load balancer maintains TLS-secured connections with external clients but relies on unencrypted private network communications internally (from the load balancer to backend nodes). Attackers gaining access to this private network or compromising the load balancer could intercept and access sensitive unencrypted data streams.

Inadequate Client-side Verification: Clients interacting with server nodes without robustly verifying the application's execution within a genuine TEE environment. Attackers could exploit this by redirecting clients to compromised or malicious servers, leading to potential data breaches.

To mitigate these risks, some embodiments provide a comprehensive solution comprising a runtime library, an SDK, and/or deployment scripts. Some embodiments enable organizations to transition existing workloads processing sensitive data into confidential computing environments with minimal manual configuration. By leveraging automated, opinionated security configurations, some embodiments ensure secure defaults and systematically prevent the misconfigurations outlined above.

Some embodiments provide a secure container 1700, which enhances traditional containers by embedding additional security functionality and enforcing specific guarantees:

The secure container 1700 of some embodiments may always be executed within the TEE 1705, such as a Confidential VM and/or Confidential GPU.

The secure container 1700 of some embodiments securely manages an encryption key used for both communication and data encryption/decryption exclusively within the TEE.

The secure container 1700 of some embodiments provides an API endpoint for obtaining cryptographic remote attestation tokens, facilitating verification of node integrity.

The secure container 1700 of some embodiments encrypts all container communications using a key managed securely within the TEE.

Some embodiments are designed to be highly transparent, requiring minimal modifications to workloads running within them, as well as minimal adjustments to external servers or clients (including browsers) communicating with the containers. In scenarios where modifications are necessary—for example, enabling clients to communicate securely with the secure container 1700—an SDK may be provided in some embodiments, that includes utility functions to simplify implementation. Additionally, secure container 1700 may support flexible deployment options, available directly via cloud service providers, as well as through scripts.

### Architecture Overview

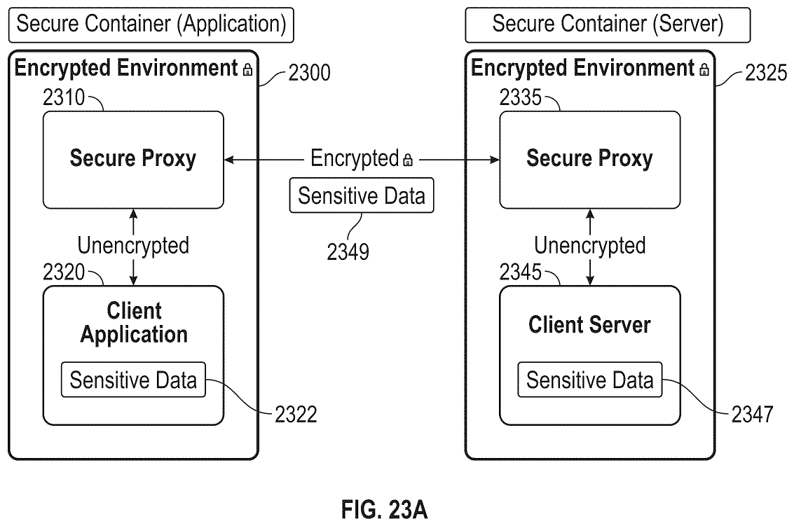

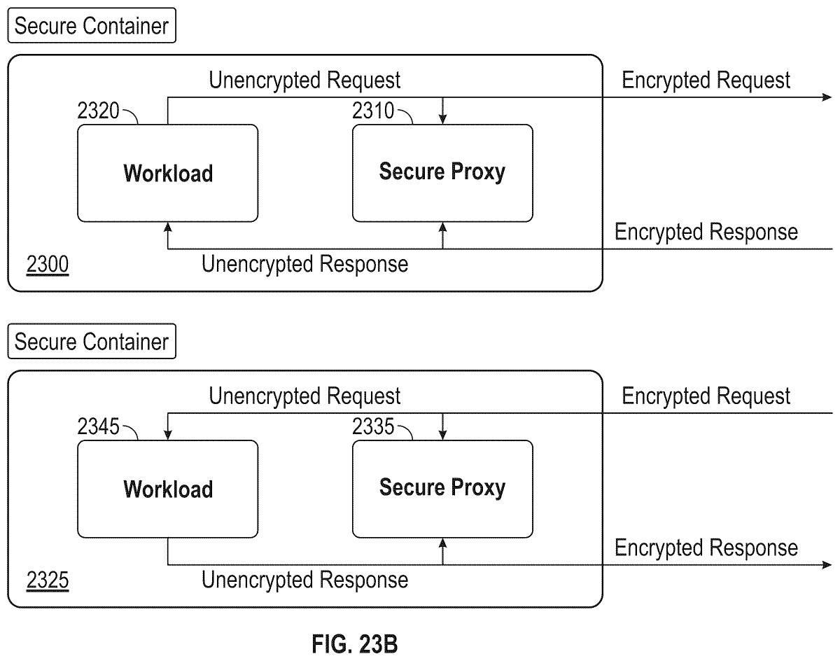

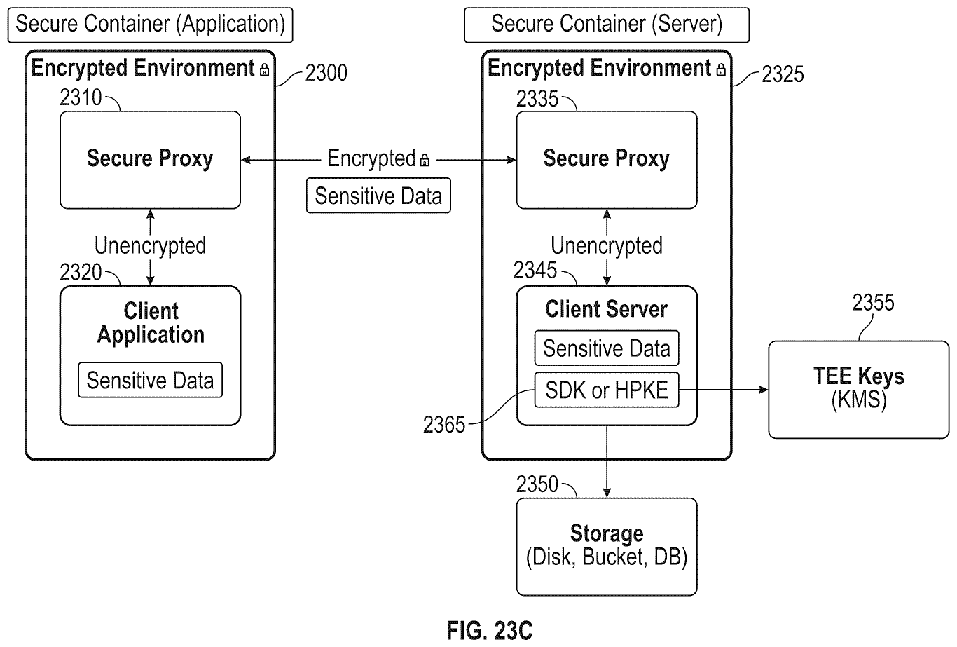

In some embodiments, the secure container 1700 comprises two components: the secure proxy 1710 and the client workload 1720. The client workload 1720 represents an application wrapped within the secure container 1700, and both components may be implemented as containers within the TEE 1705. The secure proxy 1710 acts as a sidecar container alongside the client workload 1720, managing all external communication and/or encryption. In deployments involving confidential GPUs, a portion of the client workload 1720 may execute directly on the GPU (e.g., as a client server, as described with reference to FIGS. 23A-23C below).

Additionally, the secure proxy 1710 may in some embodiments be responsible for managing a private key securely within the TEE 1705. This key can either be ephemeral, generated within the TEE 1705 by a key management module 1730, or managed externally through a Key Management Service (KMS) backed by HSM 1740. When an external KMS is utilized, access to the private key may be strictly governed by the attestation policy 1707, ensuring the key's usage exclusively within the TEE. The secure proxy 1710 may manage all necessary interactions, including remote attestation with the KMS, to securely retrieve and utilize the key within the TEE 1705.

In some embodiments, the private key may serve multiple purposes, including but not limited to encrypting and decrypting communications between the container and external services, and securing data stored persistently on devices such as disks, block storage, or databases. The corresponding public key may be exposed via a secure proxy API endpoint, enabling clients to encrypt data before transmitting it to the secure container.

In some embodiments, the secure proxy 1710 provides an API endpoint that publishes a cryptographic remote attestation token. This token simplifies verification of the integrity and security attributes of the underlying hardware.

In some embodiments, the secure proxy 1710 is a runtime library that operates within the secure container 1700, positioned in front of the client workload 1720, and may perform several functions, including but not limited to: encrypting and decrypting all communication between the client workload 1720 and external networks; providing cryptographic remote attestation tokens, enabling clients to verify the integrity of the underlying hardware securely; and managing the encryption keys utilized for communication and data protection.

In some embodiments, the secure container 1700 proxies all external communications through the secure proxy 1710, allowing fully encrypted communication to occur transparently without modifying the client workload 1720. However, achieving end-to-end encryption requires clients communicating with the secure container 1700 also to implement encryption. Some embodiments provide an SDK to simplify this integration for client-side encryption.

In some embodiments, encryption can be implemented at various levels of the Open Systems Interconnection (OSI) model. Encrypting communication at the HTTP protocol level offers easier client integration, although it does not support all scenarios since some workloads may not utilize HTTP. For broader compatibility, some embodiments also support encryption at the TCP level, suitable for nearly all workloads. However, client-side integration at the TCP level typically involves running a corresponding proxy, which might add complexity.

In some embodiments, when input encryption is enabled, the secure proxy 1710 expects incoming HTTP requests to be encrypted using the secure container's public key. The secure proxy 1710, having access to the corresponding private key (see Key Management, described below), decrypts request URLs, headers, and bodies, forwarding them unencrypted to the client workload 1720. In some embodiments, when output encryption is activated, the secure proxy 1710 encrypts responses using the client's public key (provided in the initial request). Consequently, the client workload requires no modification, continuing unencrypted communication internally within the secure container.

In some embodiments, similar to the HTTP proxy, the TCP proxy within the secure container 1700 expects incoming TCP payloads to be encrypted using the container's public key. Payloads are decrypted before being passed to the client workload 1720, and responses from the client workload 1720 are encrypted at the TCP level before transmission outside the secure container 1700.

### Integrated Encryption Scheme

The ability to encrypt and decrypt data within the secure container 1700 is part of the security model of some embodiments. To ensure data is never exposed unencrypted, data decryption is strictly limited to within the TEE 1705, in some embodiments leveraging Confidential VM technology for encrypted and isolated memory. Traditional symmetric encryption may be insufficient, as it would necessitate sharing encryption keys with external clients, creating vulnerabilities.

To balance security with performance requirements, particularly when encrypting large data volumes with low latency (such as HTTP or TCP traffic), some embodiments employ a hybrid encryption scheme combining asymmetric and symmetric encryption: RSA asymmetric encryption (4096-bit keys with OAEP padding) is used for securely exchanging symmetric encryption keys, and AES-256-GCM symmetric encryption efficiently encrypts the actual data.

In some embodiments, for each communication session, a random symmetric key and Initialization Vector (IV) are generated. The symmetric key and IV are encrypted using the container's public RSA key, then packaged alongside the authentication tag. The hybrid encryption approach effectively combines the strong security properties of asymmetric encryption (no need for private key sharing) with the performance advantages provided by symmetric AES-256-GCM encryption.

FIG. 17B illustrates the layout of an encrypted message 1790, according to some embodiments. The header 1791 of the encrypted message 1790 comprises fields for a size 1792, a wrapped symmetric key 1793, a wrapped IV 1794, and auth tag 1795. The rest of the encrypted message 1790 comprises ciphertext 1796.

### Remote Attestation

In some embodiments, remote attestation enables any user interacting with a secure container to verify that the container environment is indeed hosted on a confidential CPU and is properly secured. The secure proxy 1710 simplifies this process by handling all necessary configuration details and underlying system interactions required to generate a signed remote attestation token. The token may be conveniently exposed via a dedicated public endpoint, e.g.:
https://<POLARIS-CONTAINER-URL>/polaris-container/attestationToken

In some embodiments, the secure proxy 1710 abstracts away platform-specific differences across cloud environments. When combined with an SDK (see below), clients benefit from a streamlined verification process, allowing integrity checks of the secure container through a single high-level SDK function call. This design ensures that no modifications to the client workload 1720 are necessary.

A responsibility of the secure proxy 1710 is managing access to the private encryption key used to decrypt incoming requests to the secure container or data stored in persistent storage. This may be partially handled by the key management module 1730 and/or the HSM 1740, in various embodiments. Some embodiments support at least two key management options: Ephemeral Keys stored securely within memory inside the TEE, and External Key Storage via a Key Management Service (KMS).

Ephemeral keys are used in some embodiments for short-lived data encryption scenarios. These keys are dynamically generated and securely maintained in memory within the secure container, benefiting from the encrypted and isolated memory provided by the TEE 1705. When configured for ephemeral key use, the secure proxy 1710 may automatically generate an RSA 4096-bit asymmetric key pair upon startup. Due to their transient nature, ephemeral keys should not be utilized for encrypting data intended for permanent storage, as each container restart results in the generation of a new key.

Permanent data encryption requires robust external key storage. Some embodiments integrate with external Key Management Services (KMS) backed by the HSM 1740 and safeguarded through the attestation policy 1707.

Utilizing the HSM 1740 ensures the highest security for stored key material, while the attestation policy 1707 enforces key usage exclusively within the TEE 1705. Before allowing the secure proxy to use a key, the KMS may validate a remote attestation token, provided by the CPU via the secure proxy 1710, confirming that the key will only be utilized within an authorized Confidential VM. This functionality must be supported by the chosen external KMS provider.

In some embodiments, the secure proxy 1710 automates the process of obtaining the remote attestation token from the underlying hardware and submitting it for validation to the KMS, eliminating manual handling by secure container users.

Clients or external services that wish to securely communicate with the Polaris Container or encrypt data using the container's public key may, in some embodiments, retrieve the public key from the secure proxy 1710 from a public key endpoint, e.g.:
https://<POLARIS-CONTAINER-URL>/polaris-container/publicKey.

Use of such an endpoint facilitates verification of the secure container's remote attestation token, enabling clients to securely establish communications with minimal configuration. For scenarios requiring additional security assurances, the container's public key can also be independently obtained directly from the external KMS.

FIG. 17C illustrates a use case of the secure container 1700 with user key management API as a software-as-a-service (SaaS), according to some embodiments. The TEE 1705 executes a secure decryption module 1770 and a secure authentication module 1772, which are used to store/generate encrypted user keys 1774 and to provide a key encryption key 1776. One or more of the secure decryption module 1770 and secure authentication module 1772 may be components of the key management module 1730, or integrate the key management module 1730 as a component thereof.

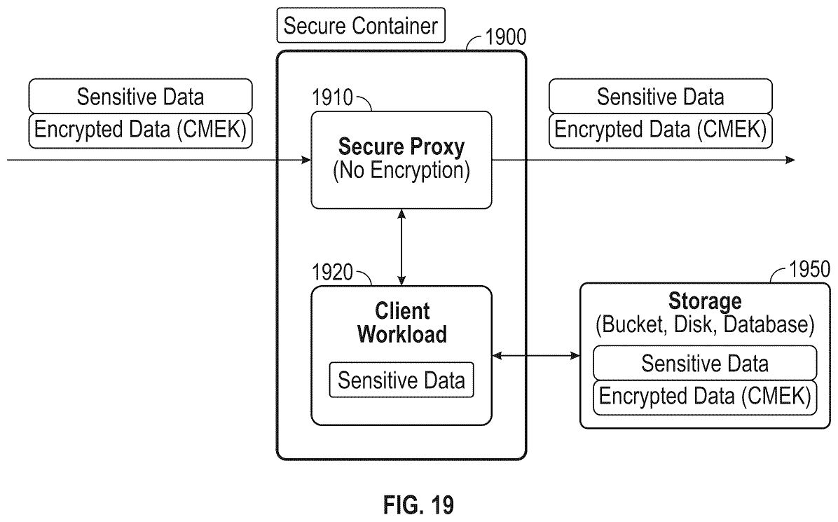

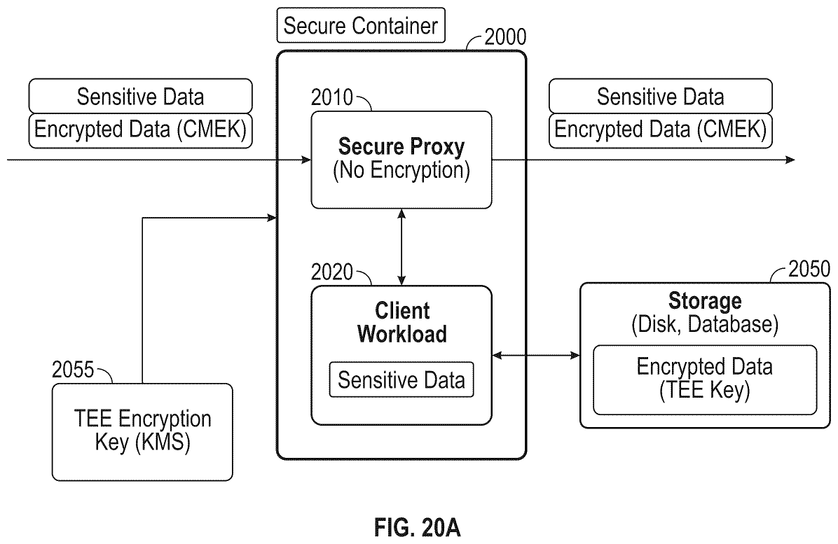

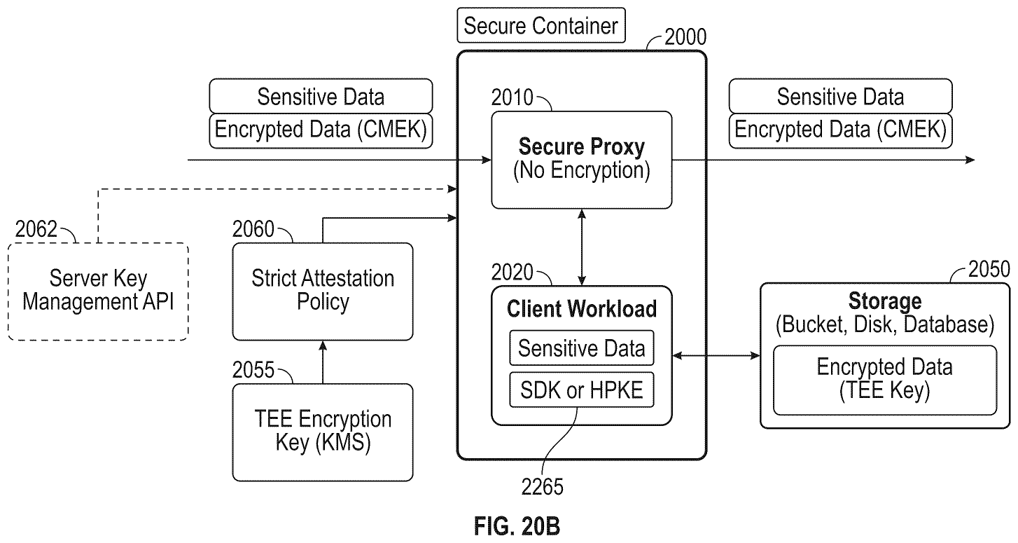

If the data is to be persisted, the client may solve the management of the user's encryption key, which may in some embodiments be done using a user key management API as an SaaS. This may be combined with additional solutions to protect the input and the storage as needed (as described below with reference to FIGS. 19 and 20).

FIG. 17D illustrates a use case of the secure container 1700 with a user key management extension 1780. To simplify key management, some embodiments offer a Software-as-a-Service (SaaS)-based solution that manages keys on behalf of users. Additionally, some embodiments provide a user-facing application 1785 (e.g., a web interface) for configuring keys and the attestation policy 1707 with strict access controls in place, further reducing the risk of misuse or unauthorized access.

### Secure Software Development Kit (SDK)

Some embodiments include a secure SDK, which may be leveraged internally by the secure proxy 1710 but also may provide functionality explicitly designed for developers integrating the secure container 1700 into broader system architectures. The SDK supports use cases both for clients interacting with the secure container 1700 and for the client workload 1720 in specific scenarios.

The SDK may be provided in any language, including TypeScript, compatible with both Node.js and browser environments. Below, various primary modules and associated use cases supported by the secure SDK are described.

In some embodiments, the secure SDK implements encryption and decryption routines consistent with an Integrated Encryption Scheme (as described above). Developers may utilize these routines for encrypting and decrypting data both client-side and within the client workload 1720 itself, such as, in a non-limiting example, when the client workload 1720 needs to securely decrypt data retrieved from permanent storage (e.g., storage 1750).

In some embodiments, the secure SDK defines an abstract Key Handler interface, which integrates seamlessly with the encryption and decryption routines. Some implementations include ephemeral key management as well as external Key Management Services (KMS) from Cloud Service Providers (CSPs). Developers can extend this interface to accommodate additional KMS providers, facilitating integration with the secure container 1700.

For scenarios requiring the use of secure container-managed keys within the client workload 1720, in some embodiments the secure SDK provides a dedicated Key Handler. In this use case, when the client workload needs to decrypt data using the TEE-protected key, the SDK's handler securely interacts with the secure proxy 1710 internally within the container environment.

### Encrypted Communication

In some embodiments, when the secure container 1700 has encrypted communication enabled, client applications must correspondingly encrypt outgoing requests and decrypt incoming responses. The secure SDK may simplify these operations through functions available for server-side Node.js applications as well as browser-based clients. This enables web applications to establish direct, end-to-end encrypted communication channels with backend APIs hosted inside the secure container 1700.

As a non-limiting example, for developers using the popular request library axios, the secure SDK offers interceptors, enabling encrypted communication to be activated with just two lines of code.

Some embodiments support multiple deployment methods tailored to user preferences: through cloud marketplaces (Google, Azure, etc.), Kubernetes, or using Terraform. Regardless of the selected method, the deployment scripts automatically provision and securely configure all required resources.

### Performance Evaluation

### CPU Overhead (AMD SEV-SNP)

AMD SEV-SNP enhances security by encrypting memory and isolating workloads within Trusted Execution Environments. Benchmark studies and vendor reports of some embodiments indicate that compute-intensive operations under AMD SEV-SNP may incur an overhead of approximately 3-5% compared to non-encrypted environments. This performance impact mainly arises from the additional latency introduced by hardware-assisted encryption and decryption processes. Although there is a measurable impact, these figures are generally acceptable for enterprise workloads where data confidentiality is critical.

### GPU Overhead (Confidential H100)

The Nvidia Confidential H100 GPU extends confidentiality to GPU-accelerated workloads by encrypting GPU memory and securing data transfers over the PCIe bus. Preliminary evaluations of some embodiments suggest that GPU-intensive tasks may experience an overhead in the range of 2-3% relative to standard GPU operations. This modest performance penalty is primarily due to the encryption processes integrated into the GPU's architecture, which have been optimized to minimize impact on overall throughput. Early technical analyses and vendor documentation support these estimates.

### HTTP Proxy Overhead

The secure proxy 1710 is responsible for securely managing communication and cryptographic operations. Given its role in proxying all HTTP requests and responses between clients and workloads, understanding its performance impact is essential.

Benchmark tests of some embodiments were conducted using an anonymization service demo workload to measure performance overhead. The results indicate that using the secure container 1700 without encrypted communication introduces an average overhead of only 3 ms per HTTP roundtrip, which corresponds to approximately 2.6% additional latency compared to a standard VM running the identical workload.

With input and output encryption enabled, the overhead increases to approximately 45 ms per request, representing about a 31% increase under these specific test conditions. This additional latency primarily results from encryption and decryption operations. However, this overhead scales primarily with request size rather than processing complexity. Consequently, for workloads involving more intensive operations—such as database queries or advanced data processing—the relative percentage of overhead will decrease significantly.

This section outlines the key security advantages and benefits gained by deploying workloads within the secure container 1700, according to some embodiments.

A security advantage provided by the secure container 1700 is the continuous encryption of data throughout its lifecycle. Traditionally, data encryption is implemented at rest (e.g., via Customer-Managed Encryption Keys (CMEK) in storage buckets) and in transit (e.g., using TLS connections). However, data is typically left unencrypted during processing (“in use”). Some embodiments address this vulnerability by ensuring that data decrypted for processing remains protected, as the Confidential VM's memory is itself encrypted. Consequently, data remains effectively encrypted at all stages, eliminating potential weak points in the data processing chain.

In some embodiments, another benefit of processing data within the TEE 1705 is complete isolation from the Cloud Service Provider (CSP). This isolation safeguards data against threats from malicious CSP employees or external attackers who might compromise CSP infrastructure. Such isolation is particularly valuable for organizations that traditionally require data to remain on-premises due to mistrust of cloud provider security.

Malicious or compromised internal employees, especially those with privileged administrative access, represent another significant security threat. Some embodiments enhance security by enforcing strict cryptographic verification of encryption key usage through remote attestation policies, ensuring keys can only be utilized within the verified TEE 1705. Thus, even if an administrator gains unauthorized access to encrypted data, they cannot decrypt it without appropriate authorization.

Some embodiments may provide a technological advantage to mitigate insider threats as follows:

Preventing Deployment of Malicious Workloads: A compromised administrator might attempt to deploy malicious workloads to decrypt sensitive data. Some embodiments mitigate this by integrating approved workload versions (e.g., Docker image hashes) into the attestation policy. If workload administration and attestation policy management are strictly separated, unauthorized workload versions will be blocked from accessing encryption keys, requiring attackers to compromise multiple distinct roles simultaneously.

Preventing Unauthorized Modification of Attestation Policies or Key Access Rights: By maintaining clear separation of duties between workload administrators and those managing encryption keys and attestation policies, unauthorized modifications become significantly more challenging. Attackers must therefore compromise multiple administrative roles simultaneously to succeed.

In some embodiments, including workload versions in attestation policies may be subject to certain Cloud Service Provider limitations.

In some embodiments, the secure proxy 1710 enables encryption of all communication using TEE-managed keys, adding an extra security layer beyond standard encrypted protocols like HTTPS. This additional encryption layer is beneficial and provides a technological improvement for several reasons:

Support for Non-Encrypted Protocols: Many communication protocols (e.g., SMTP, FTP, HTTP) do not natively support encryption. In some embodiments, the TCP proxy provides encryption at lower levels in the communication stack, ensuring security even for these protocols.

Security for Private Network Communication: Common industry practice often leaves communication unencrypted within private networks—typically from load balancers to backend server nodes—posing a vulnerability to CSP attackers or internal threats. Some embodiments mitigate this risk by encrypting communications using TEE-managed keys.

Resilience Against Certificate Compromise: Protocols like HTTPS depend on external certificates, which can potentially be compromised, allowing attackers to decrypt sensitive communication. In some embodiments, encryption managed within the TEE 1705 using keys is significantly more secure due to the enhanced protection of key material.

Remote Attestation Verification: In some embodiments, secure containers simplify integrity verification of server environments through a single API call. This verification process may enable applications to confirm server security, substantially reducing the risk posed by compromised infrastructure.

FIG. 17E shows a use case of the secure container 1700 for artificial intelligence model training and/or inference, according to some embodiments. For example, training weights 1752 for an AI model 1754 may be provided from the client workload 1720. In this use case, the training weights 1752 may be stored in the storage 1750. The TEE 1705 may securely communicate with another TEE 1760 executed by a GPU for training and/or inference of the AI model 1754.

Features for this use case as illustrated in FIG. 17E include encryption in use (memory encryption), encrypted input and output, encrypted GPU memory and CPU communication, permanent TEE key stored in an HSM 1740, key protection and attestation policy 1707, and encrypted AI model training weights 1752.

FIG. 17F shows a use case of the secure container 1700 for large language model (LLM) training and/or inference, according to some embodiments. In this example, the TEE 1760 executing on a GPU is used to execute an LLM model 1762, the training weights 1752 are provided from an LLM server 1764, and a vector database 1766 is used to store embeddings and documents from a retrieval-augmented generation (RAG) workload 1768. Note that the LLM server 1764 and the RAG workload 1768 may both execute within the TEE 1705 and generate separate outputs as well as securely communicate with each other and the LLM model 1762 in the TEE 1760.

Features for this use case as illustrated in FIG. 17F include encryption in use (memory encryption), encrypted input and output, encrypted GPU memory and CPU communication, permanent TEE key stored in an HSM 1740, key protection and attestation policy 1707, encrypted LLM model training weights 1752, encrypted RAG document storage, and end-to-end encrypted LLM communication.

### Other Features and Embodiments

Some embodiments include a transparent disk encryption module that uses the TEE key to automatically and transparently encrypt all data on the hard disk.

Some embodiments provide transparent encryption and decryption using the TEE key for data stored on bucket storage.

Some embodiments enable the provisioning of the key in another tenant for increased separation of roles or the use of existing keys. Furthermore, some embodiments use more than one external key, opening the doors to potential collaboration between different parties that don't trust each other and effectively implementing a Multi-Party Computation system.

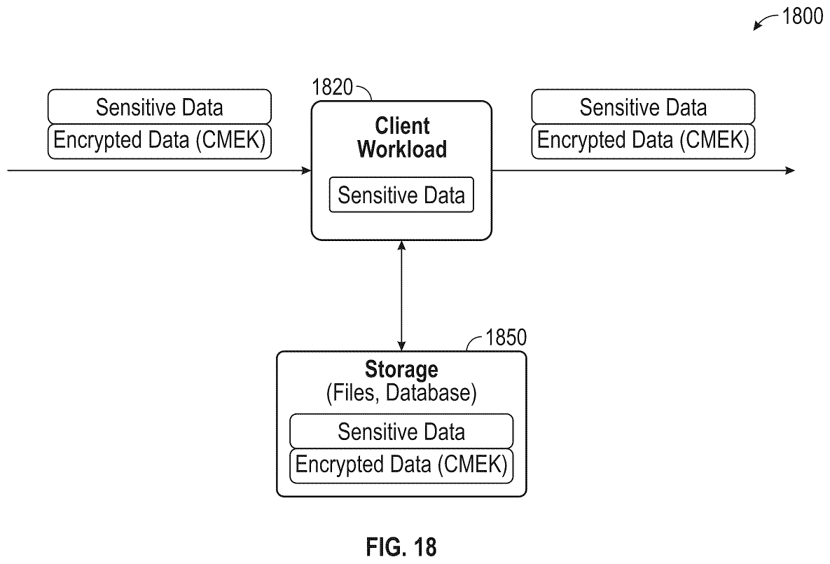

FIG. 18 illustrates a base client setup for a secure container 1800 executing a client workload 1820, according to some embodiments. Any of the various features discussed with any one of the embodiments discussed herein may also apply to and be used with any other embodiments.

In the base client setup, the client may be running some workload 1820 in the cloud operating on potentially not encrypted data. Data may be encrypted using a CMEK (customer managed encryption key), but this may not provide the highest level of isolation possible. Note that not all workloads will have sensitive data on the input, output and storage access—this example is one use case to illustrate all potential weak points.

FIG. 19 illustrates an example of protecting a workload using a secure container 1900, according to some embodiments. The secure container 1900 is similar in some respects to other embodiments discussed herein, and like reference numerals have been used to refer to the same or similar components. A detailed description of these components will be omitted, and the following discussion focuses on the differences between these embodiments. Any of the various features discussed with any one of the embodiments discussed herein may also apply to and be used with any other embodiments.

In this example, the client can run their workload 1920 in a secure container instance. This means that the memory of the machine running the workload 1920 is encrypted, but all input and output is not, as well as access to storage is not encrypted or potentially only encrypted with a CMEK. This may already add reasonable protection for some simple workloads.

Advantages of this embodiment include encryption in use and isolation of the server from the cloud service provider.

Example use-cases include, but are not limited to:

A step of a data processing pipeline that processes files on a CMEK encrypted storage, such as processing sensitive images, anonymizing sensitive data, transforming sensitive data, and the like; and

An API server/web app processing data in a CMEK encrypted storage/DB without much external input/output, such as an application where users upload sensitive documents, an application that generates summarized reports on company data (without revealing sensitive data), and the like.

FIGS. 20A and 20B illustrate an example of protecting a storage using a secure container 2000, according to some embodiments. The secure container 2000 is similar in some respects to other embodiments discussed herein, and like reference numerals have been used to refer to the same or similar components. A detailed description of these components will be omitted, and the following discussion focuses on the differences between these embodiments. Any of the various features discussed with any one of the embodiments discussed herein may also apply to and be used with any other embodiments.

In the example of FIG. 20A, the client runs their workload 2020 in a secure container instance with an access to storage 2050 that is automatically encrypted with a TEE key 2055. This means that the key needed to decrypt the data is guaranteed to only be used inside of a confidential VM. This may significantly reduce the risk of unauthorized data access both from the cloud services provider as well as from the own organization. The TEE key 2055 (actually a type of CMEK) needs to be provisioned separately. This type of encryption is supported by the cloud services providers transparently; however, it can only be used with specific types of storage (disks and self-managed DBs with own disks). This approach may require the client to extend their workload using custom encryption/decryption using a provided SDK. The approach of some embodiments can handle arbitrary storage types, including but not limited to bucket storage, managed databases, and external APIs.

Advantages of this embodiment include being easy to setup, encryption in use, isolation of the server from the cloud service provider, partial isolation from the own organization, and strong protection of suitable storage, but may not be possible using existing cloud service provider features alone. The input and output must be protected properly for this approach to be effective. Additional setup may also be needed by the client, to implement encryption and decryption in the workload.

As an example, this approach may be implemented with a managed application and confidential disk encryption. Alternatively, it may be implemented using a Kubernetes application.

Example use-cases include, but are not limited to:

A step of a data processing pipeline that processes files on a compatible storage, such as processing sensitive images, anonymizing sensitive data, transforming sensitive data, and the like; and

An API server/web app processing data in a compatible storage/DB without much external input/output, such as an application where users upload sensitive documents, an application that generates summarized reports on company data (without revealing sensitive data), and the like.

FIG. 20B illustrates improved protection of the storage 2050, by configuring the TEE key 2055 to be accessible through a strict attestation policy 2060, verifying that an approved software version is used in the workload. This may be configured by the client or outsourced as SaaS in order to strengthen the isolation from the own organization. A server key management API 2062 may also be used.

Advantages of this embodiment include being easy to setup, encryption in use, isolation of the server from the cloud service provider, full isolation from the own organization, and strong protection of arbitrary storage, but may not be possible using existing cloud service provider features alone. The input and output must be protected properly for this approach to be effective. Additional setup may also be needed by the client, to implement encryption and decryption in the workload.

As an example, this approach may be implemented with a managed application and confidential disk encryption. Alternatively, it may be implemented using a Kubernetes application, and attestation possible with a GCP confidential space.

Example use-cases include, but are not limited to:

A step of a data processing pipeline that processes file on arbitrary storage, e.g., for processing sensitive images, anonymizing sensitive data, transforming sensitive data, and the like; and

An API server/web app processing data in a compatible storage/database without much external input/output, e.g., an application where users upload sensitive documents, an application that generates summarized reports on company data, without revealing sensitive data, and the like.

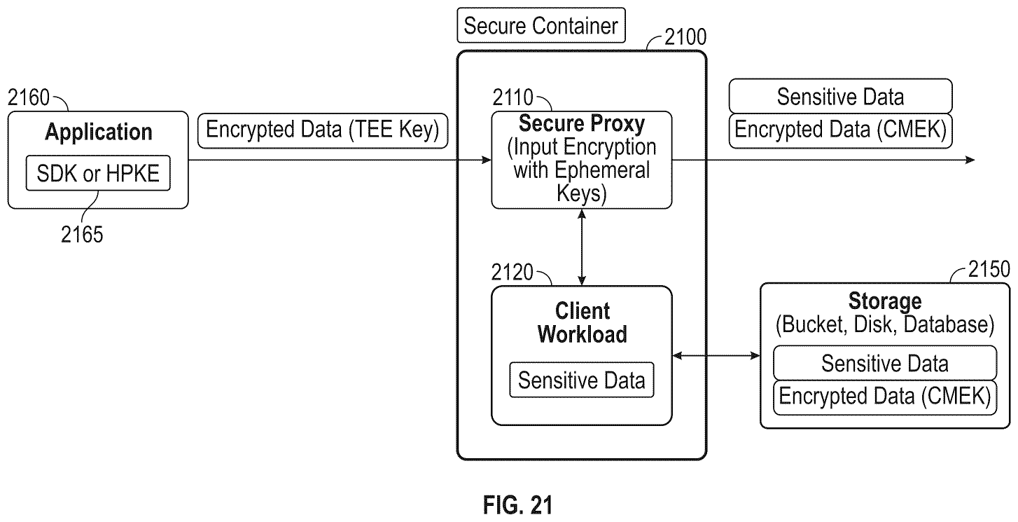

FIG. 21 illustrates an example of protecting input using a secure container 2100, according to some embodiments. The secure container 2100 is similar in some respects to other embodiments discussed herein, and like reference numerals have been used to refer to the same or similar components. A detailed description of these components will be omitted, and the following discussion focuses on the differences between these embodiments. Any of the various features discussed with any one of the embodiments discussed herein may also apply to and be used with any other embodiments.

In this example, the Secure Proxy 2110 is run with enabled input encryption and optionally with input authentication. If the application 2160 is stateless, an asymmetric ephemeral key may be used, that is created inside of the TEE and is used to decrypt all the data. As the container 2100 now expects encrypted input, the application 2160 interacting with the container 2100 needs some modifications. An SDK 2165 may be provided to implement a standard that is as generic as possible (e.g., Hybrid Public Key Encryption, HPKE). This may be combined in some embodiments with a solution for storage encryption.

Advantages of this embodiment include encryption in use, isolation of the server from the cloud service provider, isolation of all input from the cloud service provider, and isolation of all input from the own organization.

Example use cases include, but are not limited to, stateless API servers/web apps with non-sensitive output, such as an anonymization service that returns the non-sensitive content, verification servers validating data, and the like. When combined with a storage encryption solution, this can be useful also for apps that have state, e.g., large web applications focused on data ingestion and processing, and the like.

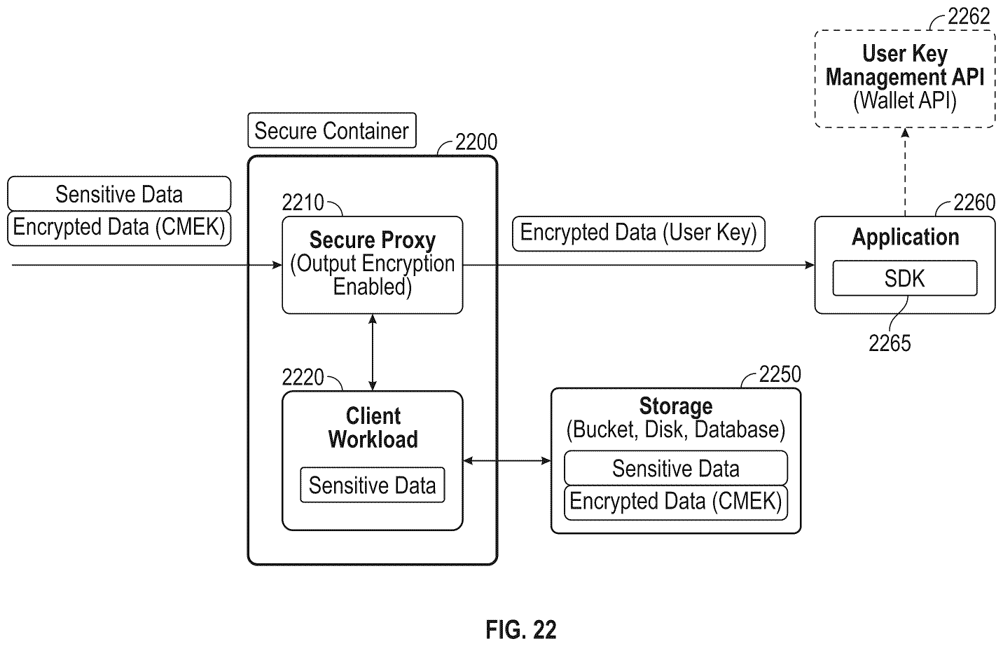

FIG. 22 illustrates an example of protecting output using a secure container 2200, according to some embodiments. The secure container 2200 is similar in some respects to other embodiments discussed herein, and like reference numerals have been used to refer to the same or similar components. A detailed description of these components will be omitted, and the following discussion focuses on the differences between these embodiments. Any of the various features discussed with any one of the embodiments discussed herein may also apply to and be used with any other embodiments.

In this example, the secure proxy 2210 encrypts the output with the public key of the user, which would typically also require input authentication to make sure it is the correct user. The client application may be extended to handle the decryption of the data. This may be done using the SDK 2265 and/or a standardized format (e.g., HPKE). If the data is to be persisted, the client may solve the management of the user's encryption key, which may in some embodiments be done using a user key management API 2262 as an SaaS. This may be combined with additional solutions to protect the input and the storage as needed (as described above with reference to FIGS. 19, 20A, and 20B).

Advantages of this embodiment include encryption in use, isolation of the server from the cloud service provider, isolation of all output from the cloud service provider, and isolation of all output from the own organization.

Example use cases include, but are not limited to, applications and/or servers processing sensitive data that is presented to the user to view (e.g., report generating servers or applications, data analysis servers or applications, and the like).

FIGS. 23A-23C illustrate an example of communication between secure containers, according to some embodiments. In this example, as illustrated in FIG. 23A, a first secure container, TEE 2300, executes a first secure proxy 2310 and a client application 2320 that processes sensitive data 2322. A second secure container, TEE 2325, executes a second secure proxy 2335 and a client server 2345 that processes sensitive data 2347.

Since the secure proxy 2310 and the client application 2320 execute within the same TEE 2300, communication and data (including but not limited to sensitive data 2322) is not encrypted between them. Likewise, since the secure proxy 2335 and the client server 2345 execute within the same TEE 2325, communication and data (including but not limited to sensitive data 2347) is not encrypted between them. However, communication of sensitive data 2349 between client application 2320 and client server 2345 is encrypted, mediated by secure proxy 2310 and secure proxy 2335.

In this example, as illustrated in FIG. 23B, the first workload (e.g., client application 2320) desires to make a request to a second workload (e.g., client server 2345), executing in the same TEE 2300. The client application 2320 provides the request to its local secure proxy 2310, with no encryption. Encryption is not necessary between the client application 2320 and the secure proxy 2310 because they execute within the same TEE 2300.

In some embodiments, as illustrated in FIG. 23C, the client server 2345 may be extended to handle the decryption of the data. This may be done using a key management service 2355 and an encryption module 2365, using an SDK and/or a standardized format (e.g., HPKE). This may be combined with additional solutions to protect the input and storage 2350 as needed (e.g., as described above with reference to FIGS. 19, 20A, and 20B).

The secure proxy 2310 then encrypts the request and communicates it to the secure proxy 2335 executing in TEE 2325. Note that TEE 2300 and TEE 2325 may be executing on the same virtual machine or instance, may be executing on different VMs or instances on the same server, or may be executing on different servers, on the same network or on different networks.

The secure proxy 2335 receives the encrypted request, decrypts it, and provides the unencrypted request to the client server 2345, executing in the same TEE 2325. The client server 2345 generates a response to the request and provides the response to its local secure proxy 2335, with no encryption. Encryption is not necessary between the client server 2345 and the secure proxy 2335 because they execute within the same TEE 2325.

The secure proxy 2310 receives the encrypted response, decrypts it, and provides the unencrypted response to the client application 2320, executing in the same TEE 2300.

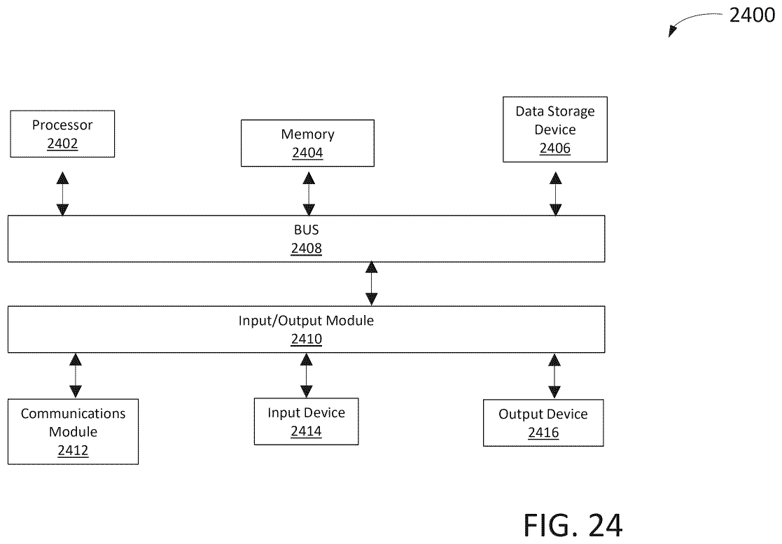

FIG. 24 is a block diagram illustrating an exemplary computer system 2400 with which aspects of the subject technology can be implemented. In certain aspects, the computer system 2400 may be implemented using hardware or a combination of software and hardware, either in a dedicated server, integrated into another entity, or distributed across multiple entities. As a non-limiting example, the computer system 2400 may be one or more of the servers 130 and/or the client devices 110.

Computer system 2400 includes a bus 2408 or other communication mechanism for communicating information, and a processor 2402 coupled with bus 2408 for processing information. By way of example, the computer system 2400 may be implemented with one or more processors 2402. Processor 2402 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 2400 can include, in addition to hardware, code that creates an execution environment for the computer program in question, e.g., code that constitutes processor firmware, a protocol stack, a database management system, an operating system, or a combination of one or more of them stored in an included memory 2404, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 2408 for storing information and instructions to be executed by processor 2402. The processor 2402 and the memory 2404 can be supplemented by, or incorporated in, special purpose logic circuitry.

The instructions may be stored in the memory 2404 and implemented in one or more computer program products, i.e., one or more modules of computer program instructions encoded on a computer-readable medium for execution by, or to control the operation of, the computer system 2400, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, Wirth languages, and xml-based languages. Memory 2404 may also be used for storing temporary variable or other intermediate information during execution of instructions to be executed by processor 2402.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 2400 further includes a data storage device 2406 such as a magnetic disk or optical disk, coupled to bus 2408 for storing information and instructions. Computer system 2400 may be coupled via input/output module 2410 to various devices. The input/output module 2410 can be any input/output module. Exemplary input/output modules 2410 include data ports such as USB ports. The input/output module 2410 is configured to connect to a communications module 2412. Exemplary communications modules 2412 include networking interface cards, such as Ethernet cards and modems. In certain aspects, the input/output module 2410 is configured to connect to a plurality of devices, such as an input device 2414 and/or an output device 2416. Exemplary input devices 2414 include a keyboard and a pointing device, e.g., a mouse or a trackball, by which a user can provide input to the computer system 2400. Other kinds of input devices 2414 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 2416 include display devices such as an LCD (liquid crystal display) monitor, for displaying information to the user.

Some embodiments may be implemented using a computer system 2400 in response to processor 2402 executing one or more sequences of one or more instructions contained in memory 2404. Such instructions may be read into memory 2404 from another machine-readable medium, such as data storage device 2406. Execution of the sequences of instructions contained in the main memory 2404 causes processor 2402 to perform the process steps described herein. One or more processors in a multi-processing arrangement may also be employed to execute the sequences of instructions contained in memory 2404. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 2400 can include clients and servers. A client and server are generally remote from each other and typically interact through a communication network. The relationship of client and server arises by virtue of computer programs running on the respective computers and having a client-server relationship to each other. Computer system 2400 can be, for example, and without limitation, a desktop computer, laptop computer, or tablet computer. Computer system 2400 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 2402 for execution. Such a medium may take many forms, including, but not limited to, non-volatile media, volatile media, and transmission media. Non-volatile media include, for example, optical or magnetic disks, such as data storage device 2406. Volatile media include dynamic memory, such as memory 2404. Transmission media include coaxial cables, copper wire, and fiber optics, including the wires that comprise bus 2408. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 2400 reads application data and provides an application, information may be read from the application data and stored in a memory device, such as the memory 2404. Additionally, data from the memory 2404 servers accessed via a network, the bus 2408, or the data storage 2406 may be read and loaded into the memory 2404. Although data is described as being found in the memory 2404, it will be understood that data does not have to be stored in the memory 2404 and may be stored in other memory accessible to the processor 2402 or distributed among several media, such as the data storage 2406.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more embodiments, the computer-readable media is non-transitory computer-readable media, computer-readable storage media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

Various practical scenarios are now described where some embodiments of secure containers may significantly enhance the security of data processing, along with recommendations for integration into existing systems.

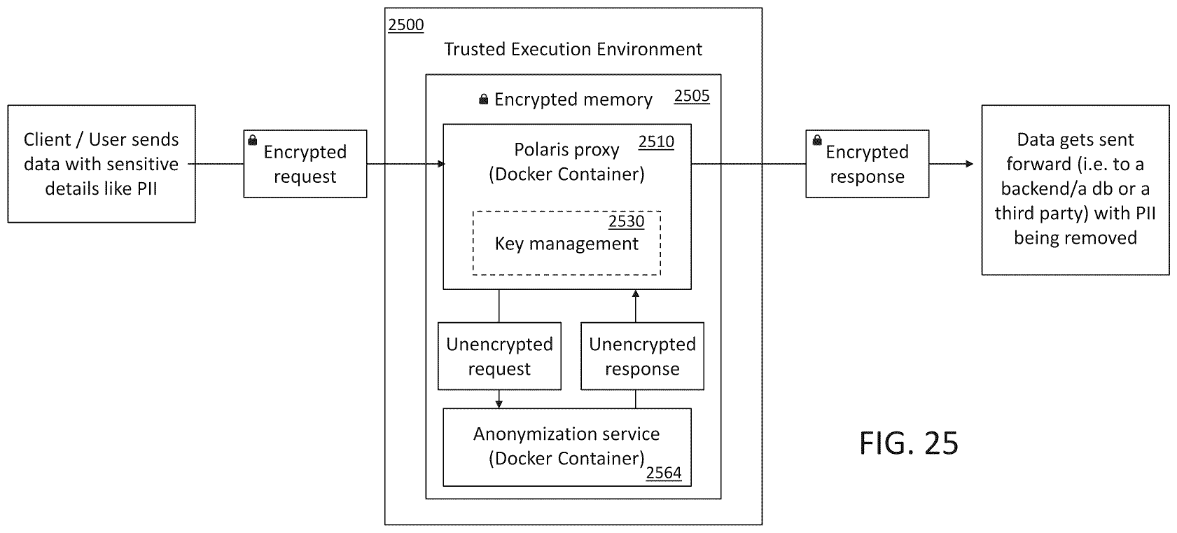

FIG. 25 is a block diagram illustrating a use case of a secure container 2500 for an anonymization service, according to some embodiments. The secure container 2500 is similar in some respects to other embodiments discussed herein, and like reference numerals have been used to refer to the same or similar components. A detailed description of these components will be omitted, and the following discussion focuses on the differences between these embodiments. Any of the various features discussed with any one of the embodiments discussed herein may also apply to and be used with any other embodiments.

Anonymization services are commonly employed to filter sensitive information from various data formats, such as text, images, and video. Typical scenarios include the removal of Personally Identifiable Information (PII) and financial details before documents are processed by third-party AI systems, or blurring faces and vehicle license plates before public dissemination. In certain situations, sensitive data may be temporarily replaced by artificially generated substitutes and subsequently restored.

Regardless of the approach, anonymization servers that handle sensitive data in unencrypted form represent potential security vulnerabilities. Deploying the anonymization server within a secure container of some embodiments effectively eliminates this vulnerability, ensuring continuous encryption of data at all processing stages—assuming encryption at rest and in transit are also enforced.

For anonymization tasks that do not require persistent encrypted storage—since anonymized data is typically no longer sensitive—the secure container 1700 of some embodiments that uses an ephemeral key is sufficient. Running the anonymization server within the TEE 1705 inherently provides robust isolation benefits. Furthermore, enabling input encryption ensures that all sensitive data transmitted to the secure container 1700 is encrypted using the TEE-managed key.

While the anonymization service itself may require no modification and can run directly within the secure container, clients transmitting data to the server must encrypt the payload before sending requests. This client-side encryption can be efficiently implemented using the secure SDK.

A compelling scenario arises when sensitive data originates directly from end-users—for example, users uploading documents or images. Since the secure SDK of some embodiments functions seamlessly within a browser environment, users can anonymize their data by directly communicating with the anonymization server via their browser. This browser-to-container communication is encrypted using the TEE-managed key, ensuring the sensitive data remains encrypted end-to-end. Consequently, sensitive user data never interacts with backend infrastructure in an unencrypted state, significantly mitigating the risk of data interception or unauthorized access.

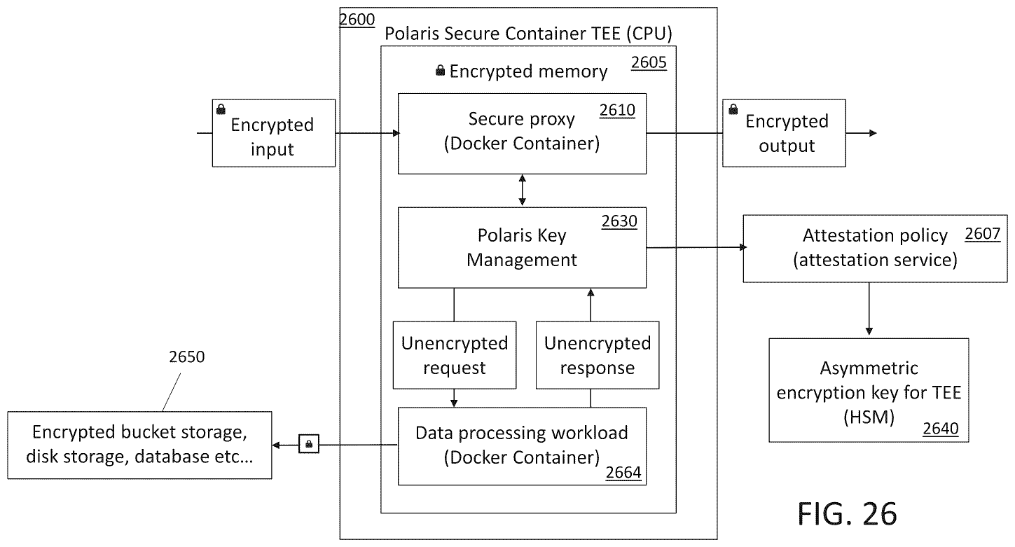

FIG. 26 is a block diagram illustrating a use case of a secure container 2600 for a data processing pipeline, according to some embodiments. The secure container 2600 is similar in some respects to other embodiments discussed herein, and like reference numerals have been used to refer to the same or similar components. A detailed description of these components will be omitted, and the following discussion focuses on the differences between these embodiments. Any of the various features discussed with any one of the embodiments discussed herein may also apply to and be used with any other embodiments.

Data processing pipelines ingest data from a source and apply multiple transformation steps until the data reaches a format suitable for specific applications. Typical examples of data processing pipelines include but are not limited to:

Extracting textual content from various file formats (PDF, XLSX, DOCX, images).

Performing sentiment analysis on text and storing classification results.

Detecting objects in images from security cameras.

Cleaning and preprocessing raw data from sensors, cameras, or other sources.

Converting images into standardized formats.

Transcoding video from one format to another.

Converting and preprocessing sensor data.

Typically, data processing pipelines run as backend jobs, retrieving data from persistent storage—such as cloud buckets—transforming it, and storing the results back into another bucket. While traditional security measures commonly encrypt data at rest (in storage buckets) and in transit (during transfer), data processing operations usually expose data in an unencrypted form while in use.

By encapsulating data processing code running inside a TEE 1705, some embodiments effectively close this security gap. For scenarios where processed data needs to be permanently stored, ephemeral keys (as used in anonymization services) are insufficient, as these keys are lost upon container restart. To address this, some embodiments offer a configuration that integrates external key management services (KMS).

In some such scenarios, the data processing job must be modified to explicitly encrypt and decrypt data using the external key managed by the KMS. The secure SDK simplifies this task in some embodiments by providing ready-to-use encryption routines, requiring minimal changes—typically just a few lines of code. This setup ensures data remains encrypted continuously, with decryption occurring exclusively inside the encrypted and isolated TEE environment.

Some embodiments provide transparent encryption and decryption support for persistent storage devices attached directly to secure containers, similar to the existing secure proxy mechanism. This eliminates the need for any modifications to workloads, further streamlining secure data processing operations.

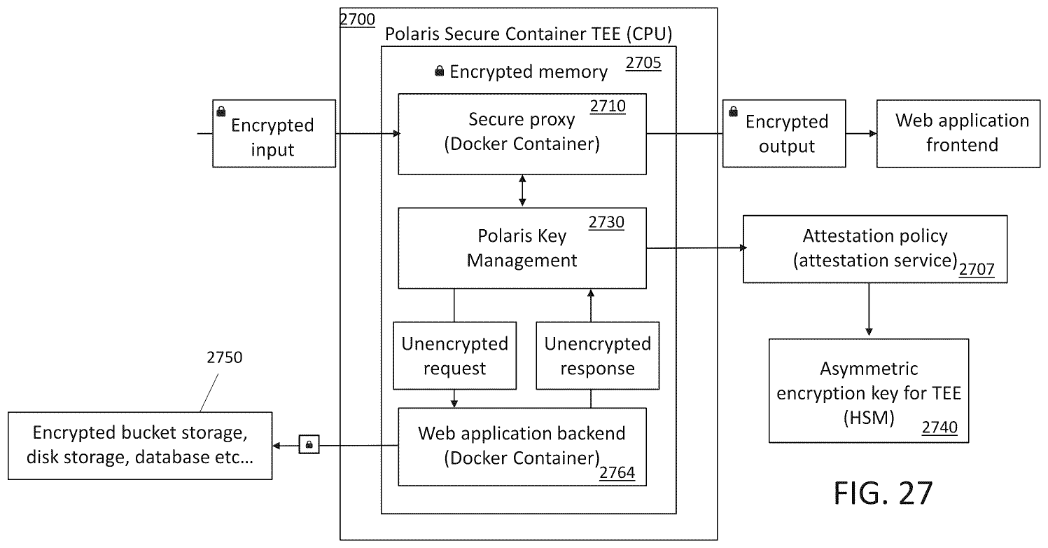

FIG. 27 is a block diagram illustrating a use case of a secure container 2700 for a web application backend, according to some embodiments. The secure container 2700 is similar in some respects to other embodiments discussed herein, and like reference numerals have been used to refer to the same or similar components. A detailed description of these components will be omitted, and the following discussion focuses on the differences between these embodiments. Any of the various features discussed with any one of the embodiments discussed herein may also apply to and be used with any other embodiments.

Web applications frequently handle sensitive information, including personal and financial data provided by users or confidential reports accessed through the interface. Specific examples include, but are not limited to, accounting applications, where employees enter financial data and generate confidential reports; data ingestion applications, for instance, handling sensitive images or documents; business intelligence applications enabling users to query and generate reports containing confidential business data; and applications integrating LLM chatbots (potentially using Retrieval-Augmented Generation, RAG), allowing users to interact securely with AI models.

Typically, web applications retrieve and process sensitive data from a backend database before sending it to users' browsers for display. As with other scenarios, the backend processing layer represents a critical vulnerability due to handling data in an unencrypted form.

In some embodiments, deploying web application backends within a TEE 1705 significantly mitigates this risk. Communication between frontend and backend can leverage the secure proxy's encrypted input and output capabilities, maintaining encryption throughout data transmission. Similar to the approach described earlier, the web application frontend must encrypt and decrypt requests and responses; this can be achieved with minimal effort using the secure SDK.

Regarding backend data processing and database interactions, sensitive data (such as social security numbers) can be encrypted using the TEE-managed key before storage and decrypted on-demand within the secure container. This method ensures data remains secure even if the database or its backups become compromised, rendering the encrypted data inaccessible to unauthorized parties.

While this strategy substantially reduces exposure risk at the backend, it requires minor modifications to backend code and impacts the database's ability to perform queries on encrypted data fields. An alternative solution of some embodiments involves hosting the entire database server within a secure container, as detailed in the subsequent section.

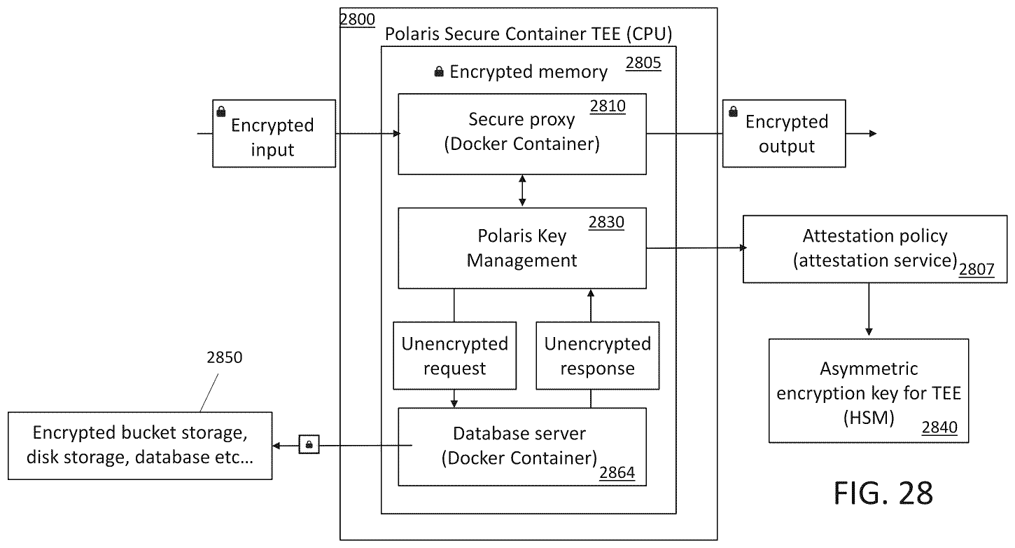

FIG. 28 is a block diagram illustrating a use case of a secure container 2800 for database servers, according to some embodiments. The secure container 2800 is similar in some respects to other embodiments discussed herein, and like reference numerals have been used to refer to the same or similar components. A detailed description of these components will be omitted, and the following discussion focuses on the differences between these embodiments. Any of the various features discussed with any one of the embodiments discussed herein may also apply to and be used with any other embodiments.

Standard best practices for securing database servers typically include restricting access by isolating them within private networks, employing robust authentication mechanisms such as passwords or certificates, and enabling encrypted communication. However, despite these measures, data within the database server is typically processed in an unencrypted form, leaving it vulnerable if the server itself is compromised.

Some embodiments address this vulnerability by deploying the entire database server within a secure container, utilizing a TCP proxy to secure and encrypt all TCP-based communications transparently. Since database servers persist data on disk, some embodiments provide a transparent disk encryption module, ensuring data remains encrypted when stored.

In some embodiments, when hosting the database server within the TEE 1705, all data remains continuously encrypted using the TEE-managed key—effectively eliminating points of exposure. When a web application retrieves data from the database, the TCP-level communication is transparently encrypted with the same TEE key, ensuring end-to-end encryption.

Unlike the previously described web application approach (Use Case 3 described above), this approach introduces no limitations on querying capabilities and requires no modifications to existing web application code, providing robust security without sacrificing flexibility or ease of integration.

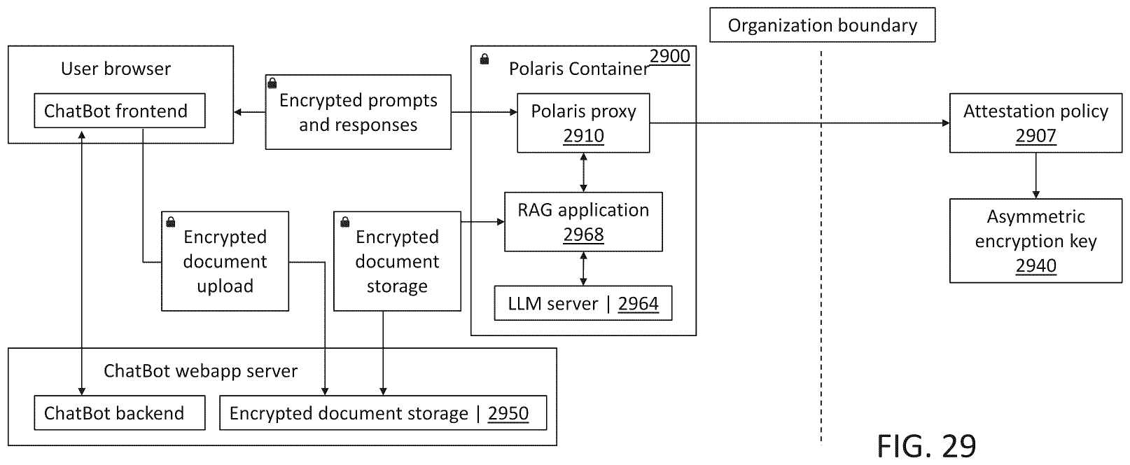

FIG. 29 is a block diagram illustrating a use case of a secure container 2900 for an end to end encrypted chatbot, according to some embodiments. The secure container 2900 is similar in some respects to other embodiments discussed herein, and like reference numerals have been used to refer to the same or similar components. A detailed description of these components will be omitted, and the following discussion focuses on the differences between these embodiments. Any of the various features discussed with any one of the embodiments discussed herein may also apply to and be used with any other embodiments.

Large Language Model (LLM)-powered chatbots are increasingly adopted by enterprises as critical business tools. Consequently, these chatbots, virtual assistants, and AI agents frequently handle sensitive data through mechanisms such as Retrieval-Augmented Generation (RAG) or fine-tuning. Additionally, confidential information is often directly shared via user prompts. Securing GPU workloads traditionally poses greater challenges compared to CPUs, as confidential computing technology for GPUs is less mature and more complex to manage.

Some embodiments enable secure deployment of GPU-intensive AI and/or LLM workloads. Practically, this allows an entire LLM server and associated RAG application to execute securely within a TEE comprising confidential CPUs and GPUs. With encrypted communication enabled, user prompts can be securely encrypted directly within the browser. Consequently, the entire communication flow—user prompts, interactions with the LLM, and server-side data handling—remains continuously encrypted. This security approach offers protection analogous to end-to-end encryption in messaging platforms, ensuring only authorized endpoints can access unencrypted data.

In some embodiments, contextual documents utilized by the RAG system can similarly be encrypted with the TEE-managed key upon upload. Despite encryption, the RAG application remains fully functional: it can leverage precomputed embeddings to identify relevant encrypted documents, securely fetch them, and decrypt on-demand before reranking or integrating them into the LLM context. Thus, some embodiments ensure comprehensive encryption and isolation for context documents, user prompts, and LLM-generated responses, providing an end-to-end secure AI chatbot environment.

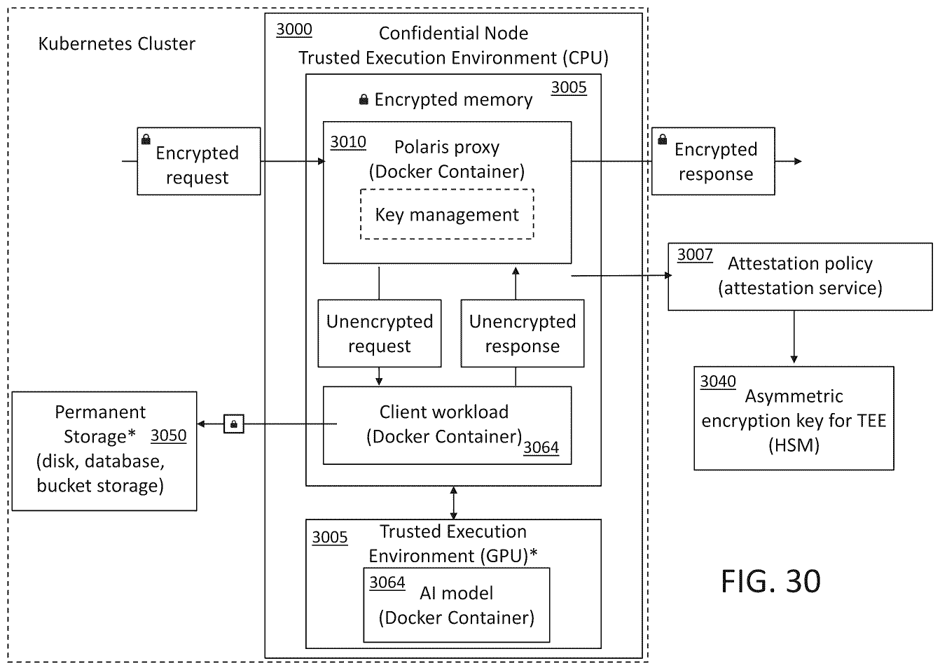

FIG. 30 is a block diagram illustrating a use case of a secure container 3000 for a Kubernetes cluster, according to some embodiments. The secure container 3000 is similar in some respects to other embodiments discussed herein, and like reference numerals have been used to refer to the same or similar components. A detailed description of these components will be omitted, and the following discussion focuses on the differences between these embodiments. Any of the various features discussed with any one of the embodiments discussed herein may also apply to and be used with any other embodiments.

Some embodiments enable the secure deployment of confidential nodes within Kubernetes clusters and offer a balance between the scalability and flexibility of Kubernetes and the robust security necessary to protect sensitive information. With seamless integration into Kubernetes environments, some embodiments ensure comprehensive data protection without requiring changes to current applications.

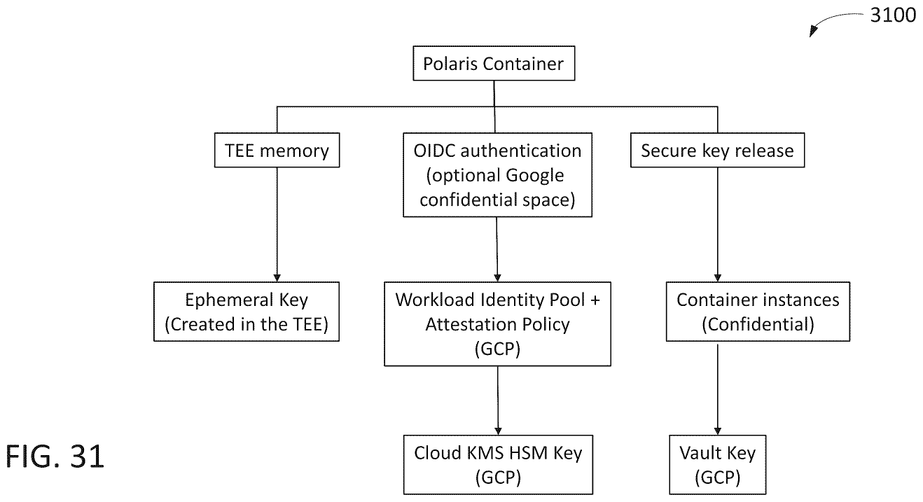

FIG. 31 is a block diagram illustrating a system 3100 with different types of keys used with a secure container, according to some embodiments. The secure container 3100 is similar in some respects to other embodiments discussed herein, and like reference numerals have been used to refer to the same or similar components. A detailed description of these components will be omitted, and the following discussion focuses on the differences between these embodiments. Any of the various features discussed with any one of the embodiments discussed herein may also apply to and be used with any other embodiments.

Some embodiments provide support for ephemeral keys, have an external key managed in via KMS service, and/or use asymmetric RSA 4096-bit encryption.

Some embodiments provide an attestation policy that includes a chip manufacturer environment. In addition, some embodiments may provide as add-ons, disabled SSH access, service account whitelists, and/or Docker image hash whitelists.

Some embodiments provide a process for attestation of confidential containers.

### State of the Machine

In some embodiments, confidential computing providers may offer the ability to generate cryptographically signed certificates that verify the integrity and, in certain cases, specific configurations of the underlying platform. These certificates may be signed using a private key embedded into the CPU during manufacturing. Verification may be subsequently conducted by employing the corresponding public key issued by the chip manufacturer, such as Intel or AMD. This verification process may remain entirely independent of the infrastructure provider (e.g., Google Cloud, Azure). This process establishes a chain of trust, beginning with the CPU manufacturer and extending to the end application, ensuring that each layer of the system adheres to defined security requirements.

Some embodiments prove the State of the Machine with a secure proxy, providing cryptographic remote attestation tokens, enabling clients to verify the integrity of the underlying hardware securely. These may be available via a dedicated API of the secure proxy.

### State of the immutable Image

A compromised administrator might attempt to deploy malicious workloads to decrypt sensitive data. Some embodiments mitigate this by integrating approved work load versions (e.g., Docker image hashes) into the attestation policy. If workload administration and attestation policy management are strictly separated, unauthorized workload versions will be blocked from accessing encryption keys, requiring attackers to compromise multiple distinct roles simultaneously. In some embodiments, secure containers may simplify integrity verification of server environments through a single API call. This streamlined verification process enables applications to routinely confirm server security, substantially reducing the risk posed by compromised infrastructure. The final remote attestation may be being achieved with a whitelist of docker image hashes and the remote attestation checking therefore the integrity of an image hash, confirming its authenticity.

### State of the Binary During Processing

Some embodiments provide an API-based attestation feature that allows clients to verify the integrity of the processing binary. This ensures that the system remains in a trusted state and matches the expected images and machine configurations throughout execution. Additionally, some embodiments perform memory checks to confirm that no malicious elements are present within the confidential areas of the container. These integrity checks may be conducted at configurable time intervals, which can be adjusted to enable near real-time monitoring of the machine's security and operational health during processing.

All references cited below or anywhere else in this specification, including the Background and Detailed Description sections, are incorporated by references as if each had been individually incorporated.
[1] M. Misono, D. Stavrakakis, N. Santos and P. Bhatotia. Confidential VMs Explained: An Empirical Analysis of AMD SEV-SNP and Intel TDX. ACM 2024
[2] J. Zhu, H. Yin and S. Zhou. Confidential Computing on nVIDIA H100 GPU: A Performance Benchmark Study. arXiv:2409.03992v1 [cs.DC] 2024

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more clauses.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

Embodiments consistent with the present disclosure may be combined with any combination of features or aspects of embodiments described herein.

1. A method for verifying transactions in a subnet by a validator node of the subnet, comprising:
receiving, from a user of the subnet, a transaction encrypted by a public key associated with an auditor of the subnet;
providing a decryption request to a digital wallet, the decryption request comprising encrypted data from the transaction;
receiving decrypted data from the digital wallet in response to the decryption request; and
using the decrypted data, performing a verification operation on the transaction.

2. The method of claim 1, further comprising determining whether the user has permission to conduct transactions on the subnet.

3. The method of claim 1, wherein the transaction is received from the user via an application executing on a user device, and the transaction was encrypted on the user device.

4. The method of claim 1, wherein the transaction comprises encrypted data fields and unencrypted metadata fields.

5. The method of claim 1, wherein the validator node is deployed in a trusted execution environment such that the operator of the node does not have access to transaction data of the validator node.

6. The method of claim 1, further comprising:
based on a determination that the transaction is valid, adding the transaction to a block of a blockchain.

7. The method of claim 1, wherein the transaction is an event from a smart contract.

8. The method of claim 1, wherein the transaction is stored in a protected memory area of the validator node prior to decryption and verification, and further comprising deleting the transaction from the protected memory area after performing the verification operation.

9. The method of claim 1, wherein the validator node uses an application programming interface of the digital wallet to provide the decryption request to the digital wallet.

10. The method of claim 1, further comprising:
receiving a query for log data associated with the transaction;
encrypting the log data using the public key associated with the auditor of the subnet, resulting in encrypted log data; and
providing the encrypted log data in response to the query.

11. The method of claim 1, further comprising:
receiving a query for data associated with the transaction;
re-encrypting the decrypted data using the public key associated with the auditor of the subnet, resulting in re-encrypted data; and
providing the re-encrypted data in response to the query.

12. A non-transitory computer-readable medium storing a program for verifying transactions in a subnet by a validator node of the subnet, which when executed by a computer, configures the computer to:
receive, from a user of the subnet, a transaction encrypted by a public key associated with an auditor of the subnet;
provide a decryption request to a digital wallet, the decryption request comprising encrypted data from the transaction;
receive decrypted data from the digital wallet in response to the decryption request; and
using the decrypted data, perform a verification operation on the transaction,
wherein the validator node uses an application programming interface of the digital wallet to provide the decryption request to the digital wallet.

13. The non-transitory computer-readable medium of claim 12, wherein the program, when executed by the computer, further configures the computer to determine whether the user has permission to conduct transactions on the subnet.

14. The non-transitory computer-readable medium of claim 12, wherein the transaction is received from the user via an application executing on a user device, and the transaction was encrypted on the user device.

15. The non-transitory computer-readable medium of claim 12, wherein the validator node is deployed in a trusted execution environment such that the operator of the node does not have access to transaction data of the validator node.

16. The non-transitory computer-readable medium of claim 12, wherein the program, when executed by the computer, further configures the computer to:
based on a determination that the transaction is valid, add the transaction to a block of a blockchain.

17. The non-transitory computer-readable medium of claim 12, wherein the transaction is an event from a smart contract.

18. The non-transitory computer-readable medium of claim 12, wherein the transaction is stored in a protected memory area of the validator node prior to decryption and verification, and the program, when executed by the computer, further configures the computer to delete the transaction from the protected memory area after performing the verification operation.

19. The non-transitory computer-readable medium of claim 12, wherein the program, when executed by the computer, further configures the computer to:
receive a query for log data associated with the transaction;
encrypt the log data using the public key associated with the auditor of the subnet, resulting in encrypted log data; and
provide the encrypted log data in response to the query.

20. A system for verifying transactions in a subnet by a validator node of the subnet, comprising:
a processor; and
a non-transitory computer readable medium storing a set of instructions, which when executed by the processor, configure the processor to:
receive, from a user of the subnet, a transaction encrypted by a public key associated with an auditor of the subnet;
provide a decryption request to a digital wallet, the decryption request comprising encrypted data from the transaction;
receive decrypted data from the digital wallet in response to the decryption request; and
using the decrypted data, perform a verification operation on the transaction,
wherein the validator node uses an application programming interface of the digital wallet to provide the decryption request to the digital wallet.
